(19) United States
(12) Patent Application Publication
(10) Pub. No.: US 2006/0157472 A1
(43) Pub. Date: Jul. 20, 2006

(54) Metal heater

(76) Inventors: Kazutaka Mashima, Gifu (JP); Yasuji Hiramatsu, Gifu (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/524,837

(22) PCT Filed: Aug. 20, 2003
(86) PCT No.: PCT/JP03/10481

§ 371 Date: Jul. 29, 2005

(30) Foreign Application Priority Data
Aug. 20, 2002 (JP) 2002-239810
Aug. 20, 2002 (JP) 2002-239811
Aug. 20, 2002 (JP) 2002-239812

(51) Int. Cl. H05B 3/68

(52) U.S. Cl. 219/444.1

(57) ABSTRACT

The object of the present invention is to provide a metal heater capable of quickly heating a semiconductor wafer and the like with slight unevenness of temperature at the time of heating, and causing no warping or sagging in the metal plate employed therein. The metal heater of the present invention comprises a metal plate and a heating element, wherein the metal plate has a thickness of 50 mm or less and a surface flatness of 50 μm or less, and an outer rim of a region where the heating element is formed is at a position within 25% of the diameter of the metal plate from an outer circumference of the metal plate.

### TECHNICAL FIELD

The present invention relates to a metal heater to be employed mainly in semiconductor industries and optical industries.

### BACKGROUND ART

With respect to an etching device, and a semiconductor producing/examining device including a chemical vapor deposition device or the like, metal heaters having substrates of a metal material such as stainless steel have been used.

FIG. 4 is a cross section view schematically showing the situation a silicon wafer is placed on a metal heater with a conventionally employed constitution.

In a metal heater 50, a heater 52 is installed on the bottom face of a disc-shaped metal plate 51 through an intermediate plate 61 comprising a material such as copper excellent in thermal conductivity, and the metal plate 51, the heater 52, and the intermediate plate 61 are fixed in a supporting case 60 by metal plate fixing screws 57.

The heater 52 is connected with a conductive wire 64, and the conductive wire 64 is led out to the outside through a through hole formed in the supporting case 60 and a heat shielding plate 63, and is connected to a power source or the like (not shown).

A heat insulating ring 62 is inserted between the metal plate 51 and the supporting case 60, and a heat shielding plate 63 is installed in the bottom part of the supporting case 60, so that the constitution enables to prevent heat transmission from the metal plate 51 to the device.

A bottomed hole 54 is formed in the metal heater 50, and a temperature measuring element 56 configured to measure the temperature of the metal plate 51 and connected with a lead wire is buried in the bottomed hole 54.

A semiconductor wafer 59 is placed on the metal heater 50 through the intermediary of supporting pins 58, so that the semiconductor wafer 59 can be supported and heated at a prescribed distance from a heating face 51a of the metal plate 51.

In the metal heater 50, through holes 55 penetrating the metal plate 51, the intermediate plate 61, the heater 52, and the supporting case 60 are also formed, so that the semiconductor wafer 59, an object to be heated, can be supported at a prescribed distance from the heating face of the metal heater 50 and transported by inserting pillar-shaped lifter pins or the like in the through holes 55.

### SUMMARY OF THE INVENTION

However, metal heaters with such structures have the following problems.

Metal plates to be used for the metal heaters are needed to have a thickness to a certain extent. It is because if the metal plates are thin, the rigidity are low and the metal plates are warped and sagged since the metal plates are pushed from the surrounding because of thermal expansion attributed to heating or there is a difference of thermal expansion coefficients between supporting cases and metal plates.

If such warping, sagging and the like occurs in the metal plates, a semiconductor wafer placed on the metal plates cannot be heated evenly, so that a dispersion of temperature or a damage in the semiconductor wafer is generated in some cases.

However, if the metal plates are made thick, the heat capacity of the metal plates is increased, and in the case of heating or cooling an object to be heated, the temperature of the heating faces of the metal plates cannot promptly follow the change of the voltage or the electric current applied to the heating elements, and there has been a problem that temperature control becomes difficult.

Further, there has been a problem that it takes a long time (a long recovery time) to recover the previous temperature of the heating face and productivity reduces in the case a semiconductor wafer is placed on the metal plate and the temperature of the heating face of the metal plate abruptly drops.

Further, such metal heaters may have, in the case temperature is increased, an overshoot phenomenon that the temperature temporarily goes over the set temperature. If the overshoot phenomenon occurs, it takes further longer time to bring the temperature of the heating faces of the metal plates to the set temperature.

Also, if the metal plates is made thick, there has been a problem that the entire metal heater body becomes heavy and bulky.

Additionally, along with the recent tendency of enlargement of the diameter of semiconductor wafers and the like, and other reasons, metal heaters with a larger diameter are desired. With the enlargement of the diameter of the metal plates, the uneven temperature distribution in the metal plates themselves tends to occur, and accordingly, the above temperature evenness of the semiconductor wafer is further deteriorated.

In view of the above problems with respect to conventional metal heaters, the present inventors have enthusiastically carried out investigations to obtain a metal heater capable of heating a semiconductor wafer and the like quickly with little temperature unevenness at the time of heating and scarcely causing warping or sagging of a metal plate. Based on the results of the investigations, inventors have found that the temperature can be increased quickly and the heating face can have an even temperature by making the metal plate thin, adjusting the flatness of the metal plate to a certain value or less, and improving the shape of the heating element, and have completed a first aspect of the present invention.

Specifically, a metal heater of the first aspect of the present invention is a metal heater comprising a metal plate and a heating element, wherein the metal plate has a thickness of 50 mm or less and a surface flatness of 50 μm or less, and an outer rim of a region where the heating element is formed is at a position within 25% of a diameter of the metal plate from an outer circumference of the metal plate. Incidentally, it is desirable that the flatness is within the above-mentioned range at 500° C. or less in atmospheric gas.

The metal plate of the metal heater of the first aspect of the present invention has a thickness as small as 50 mm or less. Accordingly, the temperature of the heating face of the metal plate promptly follows the change of the voltage or the electric current applied to the heating element. As a result, an object to be heated such as a semiconductor wafer can quickly be heated.

The thickness of the metal plate in the metal heater of the first aspect of the present invention means: the thickness of the metal plate in the case the heating element is installed in the bottom face of the metal plate; and the total thickness of metal plates in the case the heating element is sandwiched in a plurality of metal plates.

Further, since the metal plate is excellent in temperature-following character, when a semiconductor wafer is placed on the heating face of the metal heater in the semiconductor producing/examining process, the time (the recovery time) taken to bring the decreased temperature back to the previous temperature can be shortened, so that the throughput time can be shortened and productivity can be improved.

The reasons for the accomplishment of such a metal heater having a thin metal plate with an excellent flatness will be described later.

It is desirable that the thickness of the metal plate constituting the metal heater of the first aspect of the present invention has an upper limit of 30 mm. If it exceeds 30 mm, heat transmission is difficult and heating efficiency tends to drop. The upper limit is more desirably 20 mm.

On the other hand, it is desirable that the thickness of the metal plate has a lower limit of 3 mm. If it is less than 3 mm, the strength of the metal plate decreases and the flatness of the metal plate tends to decrease. The lower limit is more desirably 5 mm.

The diameter of the metal plate in the metal heater of the first aspect of the present invention is desirably 200 mm or more. If the metal heater has a larger diameter, the temperature of the semiconductor wafer tends to become uneven at the time of heating and the constitution of the present invention more effectively functions. Also, a substrate having such a large diameter is capable of placing a semiconductor wafer with a large diameter. It is desirable that the diameter of the metal plate is particularly 12 inch (300 mm) or more, since it will be a mainstream for semiconductor wafer of the next generation.

The metal heater of the first aspect of the present invention may have a constitution that the heating element is installed on the bottom face of a single metal plate, or a constitution that another metal plate is attached to a heating element installed on one metal plate, that is, the heating element is sandwiched between two metal plates. Further, it may have a constitution that heating elements are inserted in three or more metal plates. It is because use of a plurality of metal plates prevents warping or sagging of the metal plates and heats a semiconductor wafer and the like evenly, even if the metal plate on the heating face side is made thin.

The thickness of the metal plate on the heating face side in the case of the above-mentioned constitution desirably has the upper limit of 30 mm and the lower limit of 3 mm, and more desirably 20 mm and 5 mm, respectively.

The metal plate constituting the metal heater of the first aspect of the present invention has a surface with a flatness of 50 μm or less. Accordingly, in the case of heating a semiconductor wafer by the metal heater of the first aspect of the present invention, the distance between the semiconductor wafer and the metal plate can be approximately even. Therefore, the entire semiconductor wafer can be heated evenly.

The above-mentioned metal plate desirably has a surface with a flatness of 30 μm or less.

The flatness in this description means the height difference between the highest part and the lowest part in the surface of the metal plate.

To obtain such a metal heater excellent in flatness, it is needed to prevent curving of the metal plate caused by pushing from side faces when the metal plate is thermally expanded. Therefore, it is desirable to keep a space so as to avoid close attachment of the side faces of the metal plate and the supporting case (a bottom plate).

To prevent the warping of the metal plate, it is desirable to press and fix the rim part of the metal plate with a presser and the like. With such a constitution, deformation of the metal plate itself attributed to the small thickness of the metal plate can be prevented, and even if a space is kept between the metal plate and the supporting case as described above, the metal plate can reliably be supported and fixed.

In addition to that, use of the same material for the metal plate and the heater fixation plate can prevent deformation of the metal plate attributed to the difference of the thermal expansion coefficients between them.

Further, it is desirable that the material constituting the metal plate is excellent in thermal conductivity, has a high rigidity, and is hardly deformed even in the case of thermal expansion and has an improved flatness on completion of processing the metal plate itself.

As a material of the metal plate constituting the metal heater of the first aspect of the present invention, for example, aluminum, an aluminum alloy, copper, a copper alloy, stainless steel, an Inconel, a steel and the like can be used. Among these, an aluminum alloy is desirable and an aluminum-copper alloy is more desirable. Since the aluminum-copper alloy has a high mechanical strength, even if the thickness of the metal plate is reduced, the metal plate is not warped or strained by heating. Therefore, the metal plate can be made thin and light. Further, since the aluminum-copper alloy is also excellent in thermal conductivity, in the case the alloy is used for the metal plate, the temperature of the heating face can promptly follow the temperature change of the heating element. That is, the heating face temperature of the metal plate can be controlled by changing the temperature of the heating element by changing the voltage or the electric current.

Besides aluminum and copper, magnesium, manganese, silicon, zinc and the like may be added to the aluminum copper alloy. It is because the processability, corrosion resistance, low thermal expansion, and other properties can be improved.

In the case aluminum, an aluminum alloy or the like is used for the material of the metal plate, it is desirable to carry out an alumite treatment for the surface of the metal plate. The alumite treatment is a treatment to form a thin coating of aluminum oxide on the surface by an electrochemical treatment (anodic oxide coating treatment) to aluminum or an aluminum alloy.

Such a treatment improves the corrosion resistance of the metal plate and hardens the surface, so that a scratch and the like on the metal plate can be avoided. Even in the case of practical use for semiconductor producing/examining process, the metal plate is hardly corroded by a resist liquid, a corrosive gas and the like.

Further, a hard alumite treatment can be carried out by performing an anodic oxide coating treatment at a lower temperature, a higher voltage, and a higher current density compared with a common alumite treatment. Such a hard alumite treatment enables to obtain a harder and thinner coating.

The thickness of the coating is desirably 1 μm or more, and a hard alumite treatment can make the thickness of the coating 3 μm or more.

In the metal heater of the first aspect of the present invention, the outer rim of the region where the heating element is formed exists at a position within a range of 25% of the diameter of the metal plate from the outer circumference of the metal plate. Generally, in the outer circumferential portion of the metal plate, heat is radiated from the outer rim part of the metal plate. Therefore, the temperature in the circumferential portion is lower than that in the center, and as a result, the temperature in the heating face tends to be uneven. However, in the metal heater of the first aspect of the present invention, since the heating element is installed in such a circumferential portion, a semiconductor wafer and the like, an object to be heated, can be heated evenly without a dispersion of temperature.

In consideration of the above-mentioned problems with conventional metal heaters, the present inventors have enthusiastically carried out investigations to obtain a metal heater capable of heating a semiconductor wafer and the like quickly with little temperature unevenness at the time of heating and scarcely causing warping or sagging of a metal plate. Based on the results of the investigations, inventors have found that the temperature can be increased quickly and the heating face can have an even temperature by using a plurality of metal plates and making the metal plate on the heating face side thin, and have completed a second aspect of the present invention.

Specifically, the metal heater of the second aspect of the present invention is a metal heater comprising a metal plate and a heating element, wherein the number of the metal plate is a plural number, the heating element is interposed between the metal plates, and the thickness of a metal plate on a heating face side is the same as or smaller than that of a metal plate on a side opposite to the heating face side.

The metal heater of the second aspect of the present invention comprises a plurality of the metal plates, and heaters are sandwiched in these metal plates. With respect to the metal heater with such a constitution, the thickness of the metal plates can be made smaller than that of a metal plate in a metal heater comprising only a single metal plate, and the heat capacity of the metal plate on the heating face side can be decreased. Therefore, an object to be heated such as a semiconductor wafer can be heated quickly.

Further, since the metal plate is excellent in temperature-following character, when a semiconductor wafer is placed on the heating face of the metal heater in the semiconductor producing/examining process, the time (the recovery time) taken to bring the decreased temperature back to the previous temperature can be shortened, so that the throughput time can be shortened and productivity can be improved.

In the metal heater of the second aspect of the present invention, the thickness of a metal plate on the heating face side is the same as or smaller than that of a metal plate on the side opposite to the heating face side.

Accordingly, even if the metal plate on the heating face side is made thin, the flatness of the heating face at the time of heating is improved by installing a metal plate with a high rigidity on the side opposite to the heating face side, so that the distance between the semiconductor wafer and the metal plate can be kept approximately even and the entire semiconductor wafer can be heated evenly.

The metal heater of the second aspect of the present invention may be constituted by installing another metal plate on a heating element installed on a metal plate, namely, the heating element is inserted between two metal plates. Further, the heating elements may be inserted in three or more metal plates.

In the case the metal heater of the second aspect of the present invention comprises three or more metal plates, the thickness of the metal plate on the heating face side means the total thickness of the metal plates existing above the heater in the lowest layer. The thickness of the metal plate on the side opposite to the heating face side means the thickness of the metal plates existing under the heater in the lowest layer.

FIG. 5 shows the constitution of a metal heater comprising three metal plates. Incidentally, only metal plates and heaters are shown in FIG. 5.

In the case of a metal heater as shown in FIG. 5, the thickness of the metal plate on the heating face side means the total thickness (a+b) of the metal plate A and the metal plate B existing above the heater B in the lowest layer. The thickness of the metal plate on the side opposite to the heating face side means the thickness c of the metal plate C existing under the heater B in the lowest layer.

Hereinafter, in the explanation of the second aspect of the present invention, a metal heater with a constitution that a heater is sandwiched between two metal plates will be mainly described. In the case the metal heater has two metal plates as described, the metal plate on the heating face side is called as the upper metal plate and the metal plate on the side opposite to the heating face side is called as the lower metal plate.

In the metal heater of the second aspect of the present invention, the upper limit of the thickness of the upper metal plate is desirably 50 mm. Since the temperature of the heating face promptly follows the change of the voltage or the electric current applied to the heating element, an object to be heated such as a semiconductor wafer can be heated quickly.

Since the metal plate is excellent in temperature-following character, when a semiconductor wafer is placed on the heating face of the metal heater in the semiconductor producing/examining process, the time (the recovery time) taken to bring the decreased temperature back to the previous temperature can be shortened, so that the throughput time can be shortened and productivity can be improved.

It is more desirable that the upper limit of the thickness of the upper metal plate is 30 mm. If it exceeds 30 mm, heat transmission is difficult and heating efficiency tends to drop.

It is desirable that the lower limit of the thickness of the upper metal plate is 3 mm. If it is less than 3 mm, the strength of the metal plate decreases and the flatness of the metal plate tends to decrease. The lower limit is more desirably 5 mm.

Desirable upper limit of the thickness of the lower metal plate in the case of the above-mentioned constitution is 47 mm and desirable lower limit is 5 mm. More desirable upper limit is 30 mm and more desirable lower limit is 10 mm.

The ratio of the thickness of the upper metal plate and that of the lower metal plate (thickness of the lower metal plate/thickness of the upper metal plate) is desirably 1 to 10. If it exceeds 10, the heat capacity of the lower metal plate is too high to quickly heat an object to be heated.

In the metal heater of the second aspect of the present invention, the diameters of a plurality of metal plates and heaters are desirably all the same. It is because heat can be transmitted to the heating face of the metal plate.

In the case, for example, a heat insulating ring and the like is inserted between the metal plates and the supporting case, the metal plates may respectively have different diameters.

The diameters of the metal plates of the metal heater of the second aspect of the present invention are desirably 200 mm or more and particularly 12 inch (300 mm) or more. The reason is the same as that for the first aspect of the present invention.

The metal plates constituting the metal heater of the second aspect of the present invention desirably have the surface flatness of 50 μm or less, more desirably 30 μm or less. The reason is the same as that for the first aspect of the present invention.

To obtain such a metal heater excellent in flatness, it is needed to prevent curving of the metal plate caused by pushing from side faces when the metal plates are thermally expanded. Therefore, it is desirable to keep a space so as to avoid close attachment of the side faces of the metal plates and the supporting case (bottom plate).

To prevent the warping of the metal plates, it is desirable to press and fix the rim parts of the metal plates with a presser and the like. The reason is same as that for the first aspect of the present invention.

In addition to that, use of the same material for the metal plates and the heater fixation plate can prevent deformation of the metal plates attributed to the difference of the thermal expansion coefficients between them.

Further, it is desirable that the material constituting the metal plate is excellent in thermal conductivity, has a high rigidity, and hardly deform seven in the case of thermal expansion and has an improved flatness on completion of processing the metal plates themselves.

A material of the metal plates constituting the metal heater of the second aspect of the present invention may be the same as the material in the first aspect of the present invention.

The material in the second aspect of the present invention is also desirably an aluminum alloy and more desirably an aluminum-copper alloy because of the same reason described above regarding the first aspect of the present invention.

In the metal heater of the second aspect of the present invention, it is desirable that the material of the upper metal plate and the material of the lower metal plate are the same. It is because deformation of warping, sagging and the like of the upper metal plate attributed to the difference of the thermal expansion coefficients between both plates can be prevented.

In the case aluminum, an aluminum alloy and the like is used for the materials of the metal plates, similarly to the first aspect of the present invention, it is desirable to carry out an alumite treatment for the surfaces of the metal plates. In the case an alumite treatment is carried out, the thickness of the coating is desirably 1 μm or more. A hard alumite treatment can make the thickness of the coating 3 μm or more.

In the metal heater of the second aspect of the present invention, it is desirable that the outer rim of the region where the heating element is formed exists at a position within a range of 25% of the diameter of the metal plates from the outer circumference of the metal plates. Generally, in the outer circumferential portion of the metal plates, heat is radiated from the outer rim parts of the metal plates. Therefore, the temperature in the circumferential portion is lower than that in the center, and as a result, the temperature in the heating face tends to be uneven. However, in the metal heater of the second aspect of the present invention, since the heating element is installed in such a circumferential portion, a semiconductor wafer and the like, an object to be heated, can be heated evenly without a dispersion of temperature.

In consideration of the above-mentioned problems with conventional metal heaters, the present inventors have enthusiastically carried out investigations to obtain a metal heater capable of heating a semiconductor wafer and the like quickly with little temperature unevenness at the time of heating and scarcely causing warping or sagging of a metal plate even if the metal plate is thin. Based on the results of the investigations, inventors have found that the temperature can be increased quickly without deformation of the metal plate even at the time of heating and the heating face can have an even temperature by improving the material for the metal plate, and have completed a third aspect of the present invention.

That is, the metal heater of the third aspect of the present invention is a metal heater comprising a metal plate and a heating element, wherein the metal plate comprises an aluminum-copper alloy.

The metal heater of the third aspect of the present invention has a metal plate comprising an aluminum-copper alloy.

Since the metal plate comprising an aluminum-copper alloy has a higher mechanical strength than a metal plate comprising solely aluminum or copper, it is not warped or strained by heating even if it is thin. Therefore, the metal plate can be made thin and light.

Since the metal plate comprising an aluminum-copper alloy is more excellent in thermal conductivity than a metal plate comprising solely aluminum, the temperature of the heating face can promptly follow the temperature change of the heating element. That is, the heating face temperature of the metal plate can properly be controlled by changing the temperature of the heating element by changing the voltage or the electric current.

Further, since an aluminum-copper alloy is excellent in cutting property, the metal plate can easily be formed into a desired shape.

The above-mentioned metal plate desirably contains 90% to 98% of aluminum.

If the content is less than 90%, the corrosion resistance may possibly be decreased, and if it exceeds 98%, the mechanical strength may possibly be decreased.

The above-mentioned metal plate desirably contains 2% to 10% of copper.

If the content is less than 2%, the strength of the metal plate is decreased, and if it exceeds 10%, the corrosion resistance is decreased.

The above-mentioned aluminum-copper alloy may contain, besides aluminum and copper, magnesium, manganese, silicon, zinc and the like. It is because the processability, corrosion resistance, low thermal expansion, and other properties can be improved.

In the case of the metal heater of the third aspect of the present invention, similarly to the first aspect of the present invention, it is desirable to carry out an alumite treatment for the surface of the metal plate. Additionally, the thickness of the coating is desirably 1 μm or more. A hard alumite treatment can make the thickness of the coating 3 μm or more.

The metal heater of the third aspect of the present invention may have a constitution that the heating element is installed on the bottom face of a single metal plate, or a constitution that another metal plate is attached to a heating element installed on a metal plate, that is, the heating element is sandwiched between two metal plates. Further, it may have a constitution that heating elements are inserted in three or more metal plates. It is because use of a plurality of metal plates prevents warping or sagging of the metal plates and heats a semiconductor wafer and the like evenly, even if the thickness of the metal plate on the heating face side is reduced.

In the metal heater with the constitution that a heating element is sandwiched between two metal plates, it is desirable that the thickness of the metal plate on the heating face side is the same as or smaller than the thickness of the metal plate on the side opposite to the heating face side.

Installation of the metal plate with a high rigidity on the side opposite to the heating face side makes it possible to maintain the strength of the entire metal heater and improves the flatness of the heating face at the time of heating, so that the distance between the semiconductor wafer and the metal plate can be kept approximately even and the entire semiconductor wafer can be heated evenly.

In the metal heater of the third aspect of the present invention, the materials of the upper metal plate and those of the lower metal plate are desirably the same. It is because deformation of the upper metal plate such as warping, sagging and the like attributed to the difference of the thermal expansion coefficients between both plates can be prevented.

Hereafter, in the explanation of the third aspect of the present invention, the metal heater with the constitution that a heater is sandwiched between two metal plates will be mainly described. In the case the metal heater has two metal plates as described, the metal plate on the heating face side is called as the upper metal plate and the metal plate on the side opposite to the heating face side is called as the lower metal plate.

In the metal heater of the third aspect of the present invention, the upper limit of the thickness of the metal plate is desirably 50 mm in the case the heating element is installed on the bottom face of a single metal plate. Since the temperature of the heating face promptly follows the change of the voltage or the electric current applied to the heating element, an object to be heated such as a semiconductor wafer can be heated quickly.

Since the metal plate is excellent in temperature-following character, when a semiconductor wafer is placed on the heating face of the metal heater in the semiconductor producing/examining process, the time (the recovery time) taken to bring the decreased temperature back to the previous temperature can be shortened, so that the throughput time can be shortened and productivity can be improved.

It is more desirable that the upper limit of the thickness of the metal plate is 30 mm. If it exceeds 30 mm, heat transmission is difficult and heating efficiency tends to drop.

In the case that the heating element is sandwiched between two metal plates, desirable upper limit of the metal plate on the heating face side is 30 mm and desirable lower limit is 3 mm. More desirable upper limit is 20 mm and more desirable lower limit is 5 mm.

The ratio of the thickness of the upper metal plate and that of the lower metal plate (thickness of the lower metal plate/thickness of the upper metal plate) is desirably 1 to 10. It is because if it exceeds 10, the heat capacity or the lower metal plate is too high to quickly heat an object to be heated.

In the metal heater of the third aspect of the present invention, the diameters of a plurality of metal plates and heater are desirably all the same. It is because heat of the heater can be uniformized and transmitted to the heating face of the metal plate.

In the case, for example, a heat insulating ring and the like is inserted between the metal plates and the supporting case, the metal plates may respectively have different diameters.

The diameters of the metal plates of the metal heater of the third aspect of the present invention are desirably 200 mm or more and particularly 12 inch (300 mm) or more. The reason is the same as that for the first aspect of the present invention.

The metal plates constituting the metal heater of the third aspect of the present invention desirably have a surface with a flatness of 50 μm or less, and more preferably 30 μm or less. The reason is the same as that for the first aspect of the present invention.

To obtain such a metal heater excellent in flatness, similar to the second aspect of the present invention, it is desirable to keep a space so as to avoid close attachment of the side faces of the metal plates and the supporting case (bottom plate). It is also desirable to press and fix the rim parts of the metal plates by a presser and the like to prevent warping of the metal plates.

In addition to that, use of the same material for the metal plates and the presser can prevent deformation of the metal plates attributed to the difference of the thermal expansion coefficients between them.

In the metal heater of the third aspect of the present invention, the outer rim of the region where the heating element is formed exists at a position within a range of 25% of the diameter of the metal plates from the outer circumference of the metal plates. The reason is same as that for the second aspect of the present invention.

### BRIEF DESCRIPTION OF THE DRAWINGS

FIG. 1 is a cross section view schematically showing one embodiment of the metal heaters according to the first to the third aspects of the present invention.

FIG. 2 is a horizontal cross section view of the heater constituting a portion of the metal heater shown in FIG. 1.

FIG. 3 is a cross section view schematically showing another embodiment of the metal heaters according to the first to the third aspects of the present invention.

FIG. 4 is a cross section view schematically showing one example of conventional metal heaters.

FIG. 5 is a cross section view schematically showing the metal plates and the heaters of the metal heater according to the second aspect of the present invention.

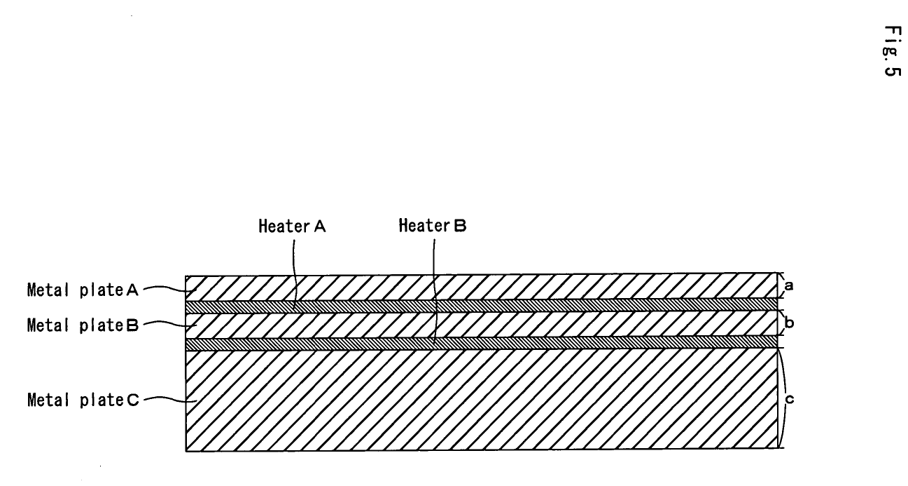

FIG. 6 is an image showing the temperature at the respective measurement points of the heating face of the metal heater according to Example 1.

FIG. 7 is an image showing the temperature at the respective measurement points of the heating face of the metal heater according to Test Example 3.

FIG. 8 is a graph showing the correlation between the temperature and the time at respective measurement points of a silicon wafer in the case the silicon wafer with a temperature of 25° C. is placed on the metal heater according to Example 2.

FIG. 9 is a graph showing the correlation between the temperature and the time at respective measurement points of a silicon wafer in the case the silicon wafer with a temperature of 25° C. is placed on the metal heater according to Test Example 1.

FIG. 10 is a drawing showing a three-dimensional shape of the heating face of the metal heater according to Example 1 at 140° C.

FIG. 11 is a drawing showing a three-dimensional shape of the heating face of the metal heater according to Test Example 2 at 140° C.

FIG. 12 is a graph showing the correlation between the temperature and the time at respective measurement points of a silicon wafer in the case the silicon wafer with a temperature of 25° C. is placed on the metal heater according to Example 7.

FIG. 13 is a drawing showing a three-dimensional shape of a part of the heating face of the metal heater according to Example 7 at ordinary temperatures.

FIG. 14 is a drawing showing a three-dimensional shape of a part of the heating face of the metal heater according to Example 7 at 140° C.

FIG. 15 is an image showing the temperature at the respective measurement points of the heating face of the metal heater according to Example 13.

FIG. 16 is an image showing the temperature at the respective measurement points of the heating face of the metal heater according to Test Example 4.

FIG. 17 is a graph showing the correlation between the temperature and the time at respective measurement points of a silicon wafer in the case the silicon wafer with a temperature of 25° C. is placed on the metal heater according to Example 14.

FIG. 18 is a graph showing the correlation between the temperature and the time at respective measurement points of a silicon wafer in the case the silicon wafer with a temperature of 25° C. is placed on the metal heater according to Comparative Example 2.

FIG. 19 is a drawing showing a three-dimensional shape of the heating face of the metal heater according to Example 13 at 140° C.

FIG. 20 is a drawing showing a three-dimensional shape of the heating face of the metal heater according to Test Example 5 at 140° C.

### EXPLANATION OF SYMBOLS

50, 110, 130 Metal heater
51, 111 Metal plate
51a, 111a, 131a Heating face
52, 112, 132 Heater
54, 114, 134 Bottomed hole
55, 115, 135 Through hole
56, 116, 136 Temperature measuring element
57, 117, 137 Metal plate fixing screw
58, 118, 138 Supporting pin
59, 119, 139 Semiconductor wafer
60, 120, 140 Supporting case
61 Intermediate plate
62 Heat insulating ring
121 Heater fixation plate
122, 142 Presser
123, 143 Heat shielding plate
124, 144 Conductive wire
125 (125a, 125b) Heating element
126 Mica plate
131 Upper metal plate
141 Lower metal plate

### DETAILED DISCLOSURE OF THE INVENTION

Hereinafter, metal heaters of the first to the third aspects of the present invention will be described in order.

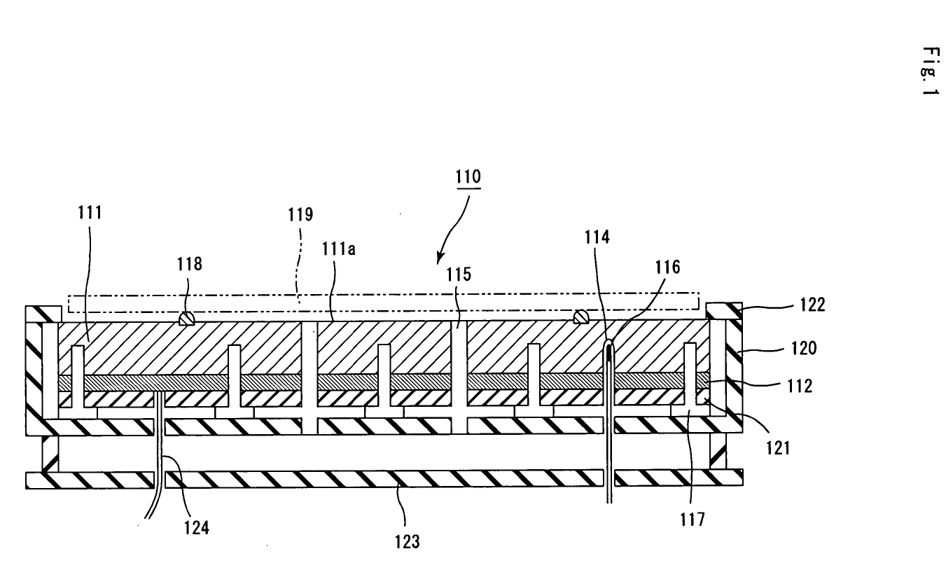

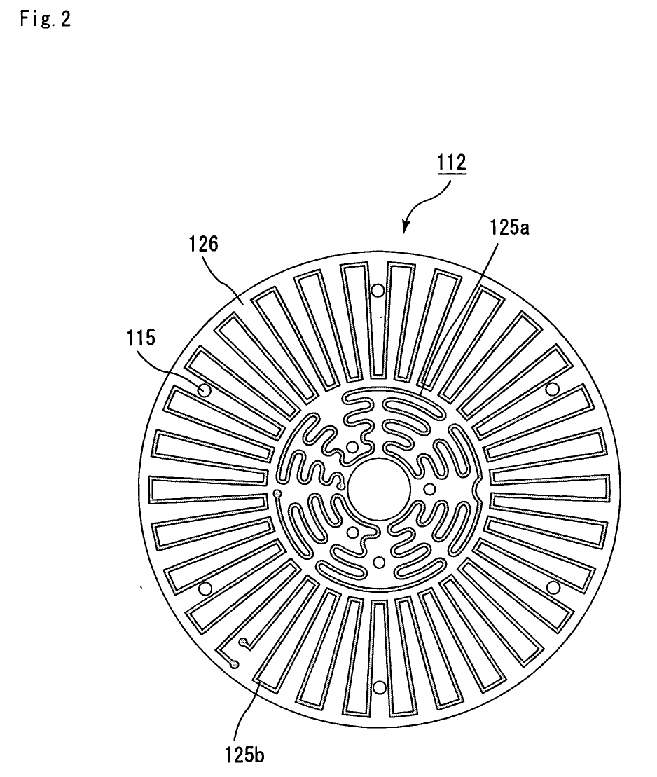

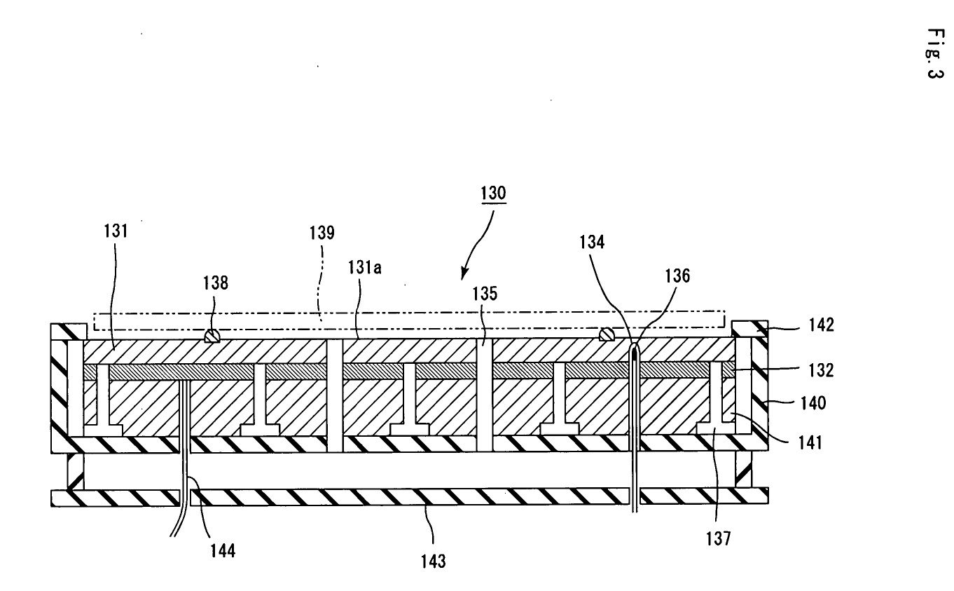

Since the respective metal heaters of the first to the third aspects of the present invention have approximately similar structure to one another, they will be described along with the same drawings (FIGS. 1 to 3). FIG. 1 is a cross section view schematically showing one embodiment of the metal heaters according to the present invention. FIG. 2 is a horizontal cross section view of FIG. 1. FIG. 3 is a cross section view schematically showing another embodiment of the metal heaters according to the present invention.

First, an embodiment of the first aspect of the present invention will be described.

The metal heater of the first aspect of the present invention is a metal heater comprising a metal plate and a heating element, wherein the metal plate has a thickness of 50 mm or less and a surface flatness of 50 μm or less, and an outer rim of a region where the heating element is formed is at a position within 25% of the diameter of the metal plate from an outer circumference of the metal plate.

First, the metal heater shown in FIG. 1 will be described.

A metal heater 110 comprises a heater 112 on the bottom face of a disc-shaped metal plate 111, and the heater 112 is fixed to the metal plate 111 by metal plate fixing screws 117 through a heater fixation plate 121.

In the metal heater 110, a heating face 111a of the metal plate 111 has a flatness of 50 μm or less. Accordingly, in the case of heating a semiconductor wafer by the metal heater 110, it is possible to keep the distance between the semiconductor wafer and the metal plate approximately even and to heat the entire semiconductor wafer evenly.

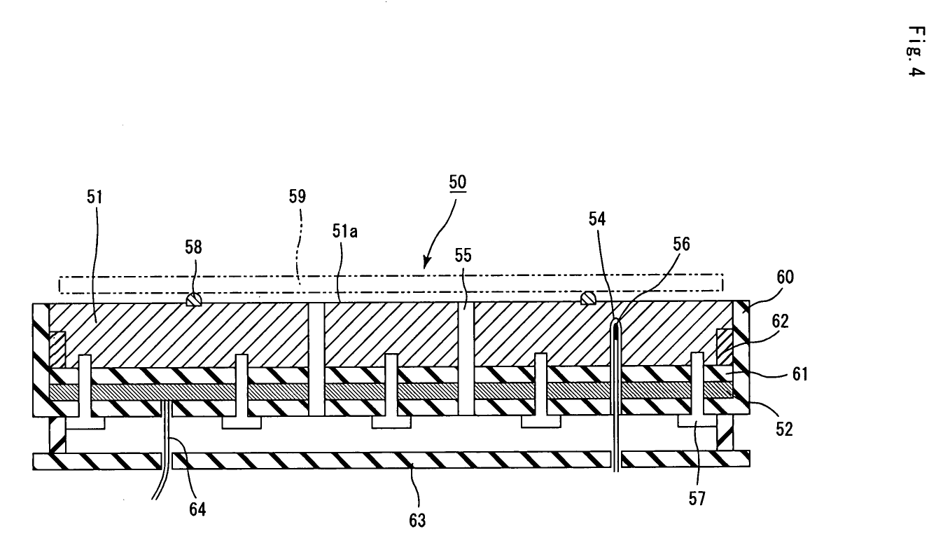

The metal heater 110 differs from the metal heater 50 shown in FIG. 4 in the following points.

First, the metal heater 100 differs from the metal heater 50 shown in FIG. 4 in that the side faces of the metal plate 111, the heater 112, and the heater fixation plate 121 are not closely attached to the supporting case 120 and fixed in non-contact state. Owing to such a constitution, curving caused by pushing from the side faces at the time of thermal expansion of the metal plate 111 can be prevented, and at the time of heating an object to be heated, heat release from the metal plate and the like is suppressed, so that the object to be heated can be heated quickly.

Also, pressers 122 are installed in the outer circumferential part of the heating face 111a of the metal plate 111. With the pressers 122 and the metal plate fixing screws 117, the metal plate 111, the heater 112, and the heater fixation plate 121 can be reliably fixed in the supporting case 120, so that occurrence of warping and sagging attributed to deformation of the metal plate 111 itself because of the small thickness of the metal plate can be prevented.

Further, the metal heater 110 shown in FIG. 1 differs from the metal heater 50 shown in FIG. 4 in the thickness of the above-mentioned metal plate and in the presence of the pressers. In addition, the metal plate fixing screws 117 do not penetrate the supporting case 120, but penetrate only the metal plate 111, the heater 112, and the heater fixation plate 121 and fix them. With such a constitution, deformation of the metal plate 111 attributed to the difference of the thermal expansion coefficients between the metal plate 111 and the supporting case 120 can be prevented, and heat release from the metal plate and the like can be suppressed at the time of heating an object to be heated. Thus, the object to be heated can quickly be heated.

A heat shielding plate 123 is installed in the bottom part of the supporting case 120. The constitution can prevent heat transmission to the device from the metal plate 111 and the heater fixation plate 121.

A bottomed hole 114 is formed in the metal heater 110 and a temperature measuring element for measuring the temperature of the metal plate 111 is embedded in the bottomed hole 114.

Further, a semiconductor wafer 119 is placed on the metal heater 110 by means of supporting pins 118 with sharpened tips, so that the semiconductor wafer 119 can be supported and heated at a prescribed distance from the heating face of the metal plate 111.

Through holes 115 penetrating the metal plate 111, the heater 112, the heater fixation plate 121, and the supporting case 120 are also formed in the metal heater 110, so that the semiconductor wafer 119, an object to be heated, can be supported at a prescribed distance from the heating face 111a of the metal plate 111 and transported by inserting pillar-shaped lifter pins and the like in the through holes 115.

The heater 112 is connected to a conductive wire 124, and the conductive wire 124 is led out to the outside through a through hole formed in the supporting case 120 and the heat shielding plate 123 and connected with an electric power source (not illustrated).

Further, as shown in FIG. 2, the heater 112 has a circular plan view shape similarly to the metal plate 111 and the heater fixation plate 121. To heat the metal plate 111 in such a manner that the temperature becomes even in the entire heating face 111a, heating elements 125a and 125b, each comprising a closed circuit, are disposed in the inside of the heater 112.

With respect to the heater 112, the heating element 125b with a closed circuit pattern comprising circular repeated winding lines is installed in the outer circumferential part of the heater 112. The heating element 125a with a closed circuit pattern comprising repeated winding lines tracing a part of a concentric circle is installed in the inside of the heating element 125b.

Further, although it is not drawn, the heating element 125 of the heater 112 is sandwiched and fixed between two mica plates 126. At the time of power application, the heating element 125 heats the mica plates 126 so as to heat the object to be heated by secondary radiation of heat from the mica plates 126.

In the case the metal heater of the first aspect of the present invention has such a structure, the metal plate 111 has a thickness of 50 mm or less and is thinner than the metal plate 51 of the metal heater 50 shown in FIG. 4. Therefore, the metal heater can heat the semiconductor wafer 119 quickly and has a shortened recovery time.

With respect to the metal heater of the first aspect of the present invention, the metal plate with a thickness of 50 mm or less and a flatness of 50 μm or less is practically employed. Accordingly, the metal heater differs from the metal heater 50 shown in FIG. 4 in the above-mentioned point.

In the case the metal heater of the first aspect of the present invention has such a structure, the outer rim of the heating element 125 formed in the inside of the heater 112 exists at a position within 25% of the diameter of the metal plate 111 from the outer circumference of the metal plate 111. Generally, in the outer circumferential portion of the metal plate 111, the temperature tends to be uneven since heat is radiated from the surface of the outer rim part of the metal plate 111. However, in the metal heater of the first aspect of the present invention, since the heating element is installed in such a circumferential portion, a semiconductor wafer and the like, the object to be heated, can be heated evenly without a dispersion of temperature.

Next, the metal heater shown in FIG. 3 will be described.

In a metal heater 130 shown in FIG. 3, a heater 132 is sandwiched between an upper metal plate 131 and a lower metal plate 141. The upper metal plate 131 and the lower metal plate 141 are fixed by metal plate fixing screws 137.

Here, the upper metal plate 131 is thinner than the metal plate 111 of the metal heater 110 shown in FIG. 1 and further thinner than the lower metal plate 141. Accordingly, the metal heater 130 shown in FIG. 3 can quickly heat an object to be heated and has a shortened recovery time.

Installation of the lower metal plate 141 having a larger thickness and a higher rigidity compared with those of the upper metal plate 131 in the bottom face of the heater 132 makes it possible to prevent deformation of the upper metal plate 131 at the time of heating.

Further, with respect to the metal heater 130, the screw heads of the metal plate fixing screws 137 are embedded in the lower metal plate 141. Accordingly, the upper metal plate 131, the heater 132, and the lower metal plate 141 can be reliably fixed in the inside of the supporting case 140, and as compared with the metal heater 110 shown in FIG. 1, deformation of warping, sagging and the like is less caused in the upper metal plate 131.

In the metal heater 130 with a structure shown in FIG. 3, a through hole is formed in the lower metal plate 141 to insert a conductive wire 134 therein, and the conductive wire 134 may be connected to a heating element installed in the inside of the heater at the side face of the heater 132.

Further, the metal heater 130 with such a structure, no screw hole is formed in the upper metal plate 131. The metal plate fixing screws 137 fix only the heater 132 and the lower metal plate 141, and the upper metal plate 131 is fixed by pressing with pressers 132 installed in the outer circumferential part of the heating face. Owing to such a constitution, deformation of the metal plate attributed to the difference of the thermal expansion coefficients between the upper metal plate 131 and the heater 132 can be prevented.

The constitution of the metal heater 130 shown in FIG. 3 other than the parts described above is the same as that of the metal heater 110 shown in FIG. 1. Therefore, explanation thereof is skipped.

In the case the metal heater of the first aspect of the present invention has the structure as shown in FIG. 3, the thickness of the metal plates (the total thickness of the upper metal plate and the lower metal plate) is 50 mm or less and the flatness of the surface is 50 μm or less, so that, as described above, the metal heater can quickly increase temperature, have a shortened recovery time, and heat the entire semiconductor wafer evenly.

Further, in the case the metal heater of the first aspect of the present invention has such a structure, although it is not illustrated, with respect to the metal heater 130, the outer rim of the heating element formed in the inside of the heater 132 exists at a position within 25% of the diameter of the upper metal plate 131 from the outer circumference of the upper metal plate 131. Accordingly, the semiconductor wafer, the object to be heated, can be heated evenly without a dispersion of temperature.

The constituent components of the metal heater of the first aspect of the present invention and a production method of the metal heater will be described later.

Next, an embodiment of the second aspect of the present invention will be described.

The metal heater of the second aspect of the present invention is a metal heater comprising a metal plate and a heating element, wherein the number of the metal plate is a plural number, the heating element is interposed between the metal plates, and a thickness of a metal plate on a heating face side is the same as or smaller than that of a metal plate on a side opposite to the heating face side.

One example of the metal heater of the second aspect of the present invention is a heater comprising two metal plates sandwiching a heater between them. Examples of the metal heater with such a constitution include the metal heater shown in FIG. 3.

In the metal heater 130 shown in FIG. 3, the flatness of the heating face 131a of the metal plate 131 is 50 μm or less, while the flatness of the heating face in the metal heater of the second aspect of the present invention is not limited to 50 μm or less.

In the case the metal heater of the second aspect of the present invention has the structure shown in FIG. 3, the outer rim of the heating element formed in the inside of the heater 132 desirably exists at a position within 5% of the diameter of the metal plate 131 from the outer circumference of the metal plate 131. Generally, in the outer circumferential portion of the metal plate 131, heat is radiated from the surface of the outer rim parts of the metal plates, and therefore, the temperature tends to be uneven. However, in the above case, since the heating element is installed also in such outer circumferential portion, a semiconductor wafer and the like, an object to be heated, can be heated evenly without a dispersion of temperature.

The constituent components of the metal heater of the second aspect of the present invention and a production method of the metal heater will be described later.

Next, an embodiment of the third aspect of the present invention will be described.

The metal heater of the third aspect of the present invention is a metal heater comprising a metal plate and a heating element, wherein the metal plate comprising an aluminum-copper alloy.

First, as one example of the metal heater of the third aspect of the present invention, a metal heater comprising a heater installed in the bottom face of a metal plate will be explained. Examples of the metal heater with such a constitution include the metal heater shown in FIG. 1.

With respect to the metal heater of the third aspect of the present invention having a structure shown in FIG. 1, the material of the metal plate 111 comprises an aluminum-copper alloy excellent in thermal conductivity and having a high mechanical strength. Therefore, the temperature of the heating face can promptly follow the temperature change of the heating element, and the heating face of the metal plate can be controlled to have a prescribed temperature. At the same time, even if the metal plate is thin, it is not warped or strained by heating. Therefore, the metal plate can be made thin and light.

In the case the metal heater of the third aspect of the present invention has the structure shown in FIG. 3, it is desirable that the metal plate 131 has a thickness of 50 mm or less.

Also, with respect to the metal heater 130 shown in FIG. 3, the heating face 131a of the metal plate 131 has a flatness of 50 μm or less, while the flatness of the heating face in the metal heater of the third aspect of the present invention is not limited to 50 μm or less.

In the case the metal heater of the third aspect of the present invention has the structure shown in FIG. 3, the outer rim of the heating element formed in the inside of the heater 132 desirably exists at a position within 5% of the diameter of the metal plate 131 from the outer circumference of the metal plate 131. The reason is the same as that described for the second aspect of the present invention.

The metal heater of the third aspect of the present invention may have the structure as shown in FIG. 3.

The constituent components of the metal heater of the third aspect of the present invention and a production method of the metal heater will be described later.

Next, the materials, shapes and the like of the metal heaters of the first to the third aspects of the present invention will be described. Here, the materials, shapes and the like of the metal heaters of the first to the third aspects of the present invention are approximately similar to one another, respectively. Therefore, they will be described collectively.

In the metal heaters of the first to the third aspects of the present invention, it is desirable to form a bottomed hole toward the heating face from the side opposite to the heating face where an object to be heated is to be placed in such a manner that the bottom of the bottomed hole is relatively closer to the heating face than the heating element, and to insert a temperature measuring element (not illustrated) such as a thermocouple into the bottomed hole.

The distance between the bottom of the bottomed hole and the heating face is desirably in the range of 0.1 mm to half the thickness of the metal plate.

It is because the temperature measurement point is closer to the heating face than the heating element and more precise temperature measurement of a semiconductor wafer is possible.

If the distance between the bottom of the bottomed hole and the heating face is less than 0.1 mm, heat is released and a temperature distribution is generated in the heating face. If it exceeds half the thickness of the metal plate, the temperature control becomes impossible since the temperature measurement is affected by the temperature of the heating element. Thus, in this case, too, a temperature distribution is generated in the heating face.

The diameter of the bottomed hole is desirably 0.3 to 5 mm. If the diameter is too large, the heat releasing property is significant. If the diameter is too small, the processability is deteriorated and the distance to the heating face cannot be even.

As the temperature measuring element, a thermocouple, a platinum resistance thermometer, a thermistor and the like can be employed.

Examples of the above-mentioned thermocouple include, as listed in JIS-C-1602 (1980), K-type, R-type, B-type, S-type, E-type, J-type, T-type thermocouples and the like. Among these, the K-type thermocouple is preferable.

The size of the connecting portion of the thermocouple is the same as or larger than the diameter of an element wire and is desirably 0.5 mm or less. If the connecting portion is large, the heat capacity is increased, so that the response deteriorates. Incidentally, it is difficult to make the size smaller than the diameter of the element wire.

The above-mentioned temperature measuring element may be joined to the bottom of the bottomed hole by using a gold solder, a silver solder, a solder, an adhesive and the like, or may be sealed with a heat resistant resin after insertion into the bottomed hole, or both means may be employed in combination.

Examples of the above-mentioned heat resistant resin include thermosetting resins, particularly, an epoxy resin, a polyimide resin, a bismaleimide-triazine resin, and the like. These resins may be used alone, or two or more of them may be used in combination.

As the gold solder, at least one selected from 37 to 80.5 wt. % Au—63 to 19.5 wt. % Cu alloys and 81.5 to 82.5 wt. % Au—18.5 to 17.5 wt. % Ni alloys may desirably be used. It is because they have a melting point of 900° C. or higher and hardly melt even in a high temperature region.

As the silver solder, for example, Ag—Cu type alloys may be used.

In the first to the third aspects of the present invention, the heater in which the heating element is formed may be put in the surface (bottom face) of the metal plate, or another metal plate may be attached to the heater disposed on one metal plate, namely, the heater is sandwiched between two metal plates.

By setting the position of the heater having the heating element as described above, during the transmission of heat generated by the heating element, the heat is diffused in the entire body of the metal plate, the temperature distribution of the face where an object to be heated (semiconductor wafer) is heated is made even, and accordingly, the temperature in the respective parts of the object to be heated is made even.

As the above-mentioned heater, a mica heater shown in FIG. 2, a silicon rubber heater and the like may be employed. Also, a heat generation wire formed on an insulating seal can be used as the heater.

As the mica heater, those obtained by sandwiching a heating element such as a Nichrome wire formed into an optional shape between mica plates, which are insulators, can be employed.

As the silicon rubber heater, those obtained by sandwiching a heating element such as a Nichrome wire formed into an optional shape between silicon rubber, which is an insulator, can be employed.

With respect to the heating element for heating the heater, any metal wires, such as a tungsten wire, a molybdenum wire, a stainless steel wire, other than the above-mentioned Nichrome wire may be used if they generate heat when voltage is applied.

Also, as the heating element, other than metal wires, metal foils can be used. With respect to the metal foil, a heating element comprising a nickel foil or a stainless foil having a pattern formed by etching is desirably used. The patterned metal foils may be stuck with resin films and the like.

Further, with respect to the insulating body for covering the heating element, any materials which can prevent short-circuit and stand for a high temperature can be used. Examples of the insulating body are not limited to the above-mentioned mica plates and silicon rubber, and may include fluoro resin, polyimide resin, polybenzimidazole (PBI) and the like. Materials obtained by forming fibers of ceramics and the like into mat-like shapes may also be used.

In the case the metal heater is of the structure comprising the heater sandwiched between the metal plates, a plurality of heaters may be installed. In such a case, it is desirable that the heating element is formed so that the patterns in respective layers complement each other, whereby any portion of the region is covered by one of these patterns when viewed from above the heating face. Examples of such a structure include checkered patterns complementing each other.

Further, in the case of arranging a heater on the surface of a metal plate, the heating face is desirably on the side opposite to the heater installation face. It is because the metal plate works as a heat diffuser to improve the temperature evenness in the heating face.

As the heating element patterns in the metal heaters of the first to the third aspects of the present invention, examples of the patterns are not limited to the one shown in FIG. 2, and may include concentric patterns, spiral patterns, eccentric patterns and the like. They may be used in combination.

Further, making the heating element pattern formed in the outermost circumference into complicatedly divided patterns enables a fine temperature control in the outer circumference of the metal heater where the temperature tends to decrease, and dispersion of temperature of the metal heater can be suppressed.

The area resistivity of the above-mentioned heating element is preferably 0.1 to 10 Ω/□. If the area resistivity exceeds 10 Ω/□, the diameter of the heating element has to be extremely small to assure the heat generation quantity, and a slight defect and the like may cause a disconnection or a fluctuation of resistivity. On the other hand, if the area resistivity is lower than 0.1 Ω/□, the diameter of the heating element has to be so large as to assure the heat generation quantity, and the freedom in designing the heating element pattern decreases and it becomes difficult to attain temperature evenness in the heating face.

As the means for connecting the heating element and an electric power source, as shown in FIGS. 1 and 3, a conductive wire may be attached to both ends of the heating element by pressure bonding and the like so as to connect the heating element to the electric power source through the conductive wire, or terminals are attached to both ends of the heating element so as to connect the heating element to the electric power source and the like through the terminals. The terminals are desirably attached to the heating element by pressure bonding.

The terminals may also be attached to the heating element by a solder. It is because nickel prevents heat diffusion of the solder. Examples of the connection terminals include outer terminals comprising Kovar.

In the case of connecting the connection terminals, solders to be used may be alloys of silver-lead, lead-tin, bismuth-tin and the like. The thickness of the solder layer is preferably 0.1 to 50 μm, since it is a sufficient range for assuring the connection by the solders.

In the metal heaters of the first to the third aspects of the present invention, an intermediate plate may be inserted between the metal plate and the heater. Inserting such an intermediate plate allows the heat generated by the heating element to be transmitted evenly to the metal plate. As the material for the intermediate plate, metals excellent in thermal conductivity, for example, copper, copper alloys and the like may be used.

Further, in the metal heater shown in FIG. 1 or 3, the side faces of the metal plates and the supporting case are in non-contact state. In the case they are brought into contact with each other, it is desirable to insert a heat shielding ring between the side faces of the metal plates and the supporting case. Occurrence of a dispersion of temperature in the heating face of the metal plate attributed to the heat release can be suppressed in the outer circumferential part of the metal plate.

The above-mentioned supporting case and the heat shielding plate may be united, or the heat shielding plate may be joined and fixed in the supporting case. It is desirable that the supporting case and the heat shielding plate are formed unitedly. It is because the strength of the entire metal heater can be assured.

The supporting case is desirably cylindrical, and the heat shielding plate desirably has a disc shape.

The thickness of the supporting case and the heat shielding plate is desirably 0.1 to 5 mm. It is because if it is less than 0.1 mm, the strength is insufficient, and if it exceeds mm, the heat capacity is increased.

The supporting case and the heat shielding plate desirably comprise SUS, aluminum, Inconel (a nickel-based alloy containing 16% of chromium and 7% of iron) and the like so as to make the processing and the like easy, give excellent mechanical properties and assure the strength of the entire metal heater.

In the case the supporting case and the heat shielding plate are not formed unitedly, materials such as heat resistant resin, ceramic plates, and composite plates of them mixed with heat resistant organic fibers or inorganic fibers, of which thermal conductivity is not so high and which are excellent in heat resistance, may be used as the heat shielding plate so as to provide an excellent heat shielding property.

Further, a coolant introducing pipe may be introduced into the supporting case or the heat shielding plate. It is because the metal heater can quickly be cooled by introducing a coolant and the like for forcible cooling of the metal heater. Further, a through hole for discharging the introduced coolant and the like for forcible cooling may be formed in the supporting case or the heat shielding plate.

Next, as one example of the production methods of metal heaters of the first to the third aspects of the present invention, a production method of the metal heater shown in FIG. 3 will be described.

Incidentally, the metal heaters of the first to the third aspects of the present invention do not necessarily have the structure with two metal plates sandwiching the heater as shown in FIG. 3.

(1) Metal Plate Production Process

Plates comprising an aluminum-copper alloy and the like are formed into a disc shape by outer diameter machining using an NC lathe, and the resulting plates are successively subjected to the end face machining, front face machining, and rear face machining.

In this case, the plate for the upper metal plate is made thinner than the plate for the lower metal plate.

Next, using a machining center (MC) and the like, parts to be the through holes to insert lifter pins for supporting a semiconductor wafer, concave portions for installing supporting pins, and a part to be a bottomed hole to embed a temperature measuring element such as a thermocouple are formed. Further, similarly, after formation of bottomed holes at prescribed positions, screw grooves are formed in the bottomed holes so as to form screw holes to insert metal plate fixing screws.

After that, by performing a surface polishing treatment on the plate for the upper metal plate by a rotary grinder, the upper metal plate and lower metal plate are produced. The surface polishing treatment gives the surface of the metal plate a flatness of about 20 to 30 μm.

Next, the above-mentioned metal plates are subjected to an alumite treatment to form an oxide coating on the surfaces of the metal plates. Such treatment improves the corrosion resistance of the metal plates and the hardness of the surfaces. Therefore, the metal plates are hardly scratched. Also, even in the case the metal heater is used practically in the semiconductor producing/examining process, the metal plate is scarcely corroded by resist liquid, corrosive gases and the like.

The above-mentioned alumite treatment (anodic oxide coating treatment) may be carried out by a sulfuric acid method, an oxalic acid method, and the like. In terms of the corrosion resistance after the treatment, the cost of an electrolytic solution, workability, and the like, the sulfuric acid method is desirably employed.

(2) Heater Installation

A heater obtained by sandwiching a heating element of a Nichrome wire and the like processed into a prescribed pattern between mica plates is inserted between the upper metal plate and the lower metal plate. The metal plates and the heater are united by inserting metal plate fixing screws into the screw holes in the metal plates and the heater and then fastening the screws.

Incidentally, since the heating element is needed to heat the entire heater evenly, it is preferably formed into a pattern basically comprising circular repeated winding lines or repeated winding lines tracing a part of a concentric circle.

Further, an intermediate plate comprising a material such as copper excellent in thermal conductivity may be sandwiched between the metal plates and the heater. The heat radiated from the heater can be thereby transmitted evenly to the metal plates.

(3) Supporting Case Installation

The device comprising the metal plates and the heater united in such a manner is supported and fixed in a cylindrical supporting case as shown in FIG. 3. A presser is installed between the outer circumferential part of the heating face of the upper metal plate and the supporting case, thereby deformation of the metal plate can be prevented and at the same time the metal plate can be more firmly supported and fixed.

Additionally, a heat shielding plate comprising the same material as that of the supporting case is installed in the bottom face of the supporting case, and through holes are formed so as to insert the temperature measuring element, the conductive wire and the like.

With respect to the metal heaters of the first to the third aspects of the present invention, as shown in FIG. 3, the metal plates and the heater are desirably supported and fixed in such a manner that the side faces of the metal plates and the heater are in non-contact state with the supporting case.

It is because the heat is released from the side faces of the metal plates and the heater, and thus the temperature in the outer circumferential part of the heating face of the metal plate may decrease.

In the case the metal plates and the heater are supported and fixed in such a manner that the side faces of the metal plates and the heater are brought into contact with the supporting case, it is desirable to insert a heat insulating ring comprising polyimide resin, fluoro resin and the like between the metal plates and the supporting case.

(4) Connection to Electric Power Source and the Like

Terminals (outer terminals) for connection to an electric power source and the like are attached to both ends of the heating element installed in the heater by pressure bonding and connected to the electric power source in the outside to complete the production of the metal heater.

The above-mentioned process of forming the through holes and the bottomed hole may be carried out after attachment of the heater to the metal plate. However, it is desirable to previously form openings for through holes and bottomed holes in the respective metal plates, the heater, and the supporting case.

In the case the metal heater is produced as described above, the upper metal plates of the heaters of the first to the third aspects of the present invention are not necessarily thinner than the lower metal plates as shown in FIG. 3, and may have the same thickness as that of the lower metal plate.

### BEST MODE FOR CARRYING OUT THE INVENTION

Hereinafter, the first to the third aspects of the present invention will be described further in detail along with examples.

In the following Examples, heaters for heating semiconductor wafers will be described. However, the heaters of the first to the third aspects of the present invention may be used as heaters for temperature adjustment of optical waveguides.

### Example 1

Production of a Metal Heater (see FIGS. 1 and 2)

(1) Plates comprising an aluminum-copper alloy (A 2219 (JIS-H4000)) were formed into a disc shape by outer-diameter machining using an NC lathe (manufactured by Washino Machinery Co., Ltd.). The disc plates were further subjected to the end face machining, front face machining and rear face machining to produce a disc plate for the metal plate and a disc plate for the heater fixation plate.

Next, using a machining center (manufactured by Hitachi Seiki Co., Ltd.), parts to be the through holes 115 to insert lifter pins for supporting the semiconductor wafer 119, concave portions for installing the supporting pins 118, and a part to be the bottomed hole 114 for embedding the temperature measuring element 116 were formed in these disc plates. Further, after the bottomed hole or through holes were formed at prescribed positions in the same manner, screw grooves were formed in the bottomed hole or through holes to form screw holes to insert the metal plate fixing screws 117 in the disc plates.

Incidentally, the through holes 115 were formed at three points, and the concave portions for installation of the supporting pins 118 were formed at four points.

(2) Next, a surface polishing treatment was performed to the surface on the heating face side of the disc plate for the metal plate produced in the step (1) by a rotary grinder (manufactured by Okamoto Machine Tool Works Ltd.) to obtain the metal plate (upper metal plate) 111 with a thickness of 20 mm and a diameter of 330 mm and the heater fixation plate (lower metal plate) 121 with a thickness of 5 mm and a diameter of 330 mm.

(3) Next, the metal plate 111 and the heater fixation plate 121 were subjected to an alumite treatment in an electrolytic solution containing 10% H₂SO₄ under the conditions of voltage 10 V, current density 0.8 A/dm², and a solution temperature 20° C. to form oxide films with a thickness of 15 μm on the surfaces of the metal plate 111 and the heater fixation plate 121.

(4) Heating elements 125a and 125b, each comprising a Nichrome wire and formed into either a pattern of circular repeated winding lines or a pattern of repeated winding lines tracing a part of a concentric circle as shown in FIG. 2, were sandwiched between two mica plates 126 with a thickness of 0.3 mm to obtain the heater 112 with a diameter of 330 mm.

Incidentally, with respect to the heater 112, the heating elements were so formed as to have the outer rim of the region where the heating elements themselves were formed beat a position of 7% of the diameter of the metal plate 111 from the outer circumference of the metal plate 111. In addition, the total number of the circuits of the heating element 125 was 4.

Parts to be the through holes 115, apart to be the bottomed hole 114, and parts to be the screw holes to insert the metal plate fixing screws 117 were previously formed in the mica plates 126.

After that, the heater 112 was sandwiched between the metal plate 111 and the heater fixation plate 121 produced in the steps (1) to (3), and the metal plate fixing screws 117 were inserted into the screw holes formed in the metal plate 111, the heater fixation plate 121, and the heater 112 and fastened to unite the metal plate 111, the heater fixation plate 121, and the heater 112.

(5) Next, the supporting case 120 comprising SUS having a cylindrical shape as shown in FIG. 1 was produced. After the parts to be the through holes 115, the part to be the bottomed hole 114, and the through hole to insert the conductive wire 124 were formed in the bottom face of the supporting case 120, the heat shielding plate 123 comprising SUS and having a disc shape was installed in the bottom part of the supporting case 120.

After that, the metal plate 111, to which the heater 112 and the heater fixation plate 121 were attached and which was produced in the step (4), was installed in the inside of the supporting case 120 having the heat shielding plate 123 therein, and a presser 122 was attached to the outer circumferential part of the heating face of the metal plate 111 to fix the metal plate 111 in the inside of the supporting case 120.

(6) After the temperature measuring element 116 for controlling the temperature was inserted into the bottomed hole 114, the bottomed hole 114 was sealed with a polyimide. The supporting pins 118 were installed in the concave portions formed in the heating face of the metal plate 111.

(7) Next, the conductive wire 124 for connecting to the electric power source was attached to both ends of the heating element installed in the heater 112 by pressure bonding and connected to an electric power source in the outside to obtain the metal heater 110.

### Example 2

Production of a Metal Heater

A metal heater was produced in the same manner as Example 1, except that the thickness of the metal plate 111 was 5 mm and the thickness of the heater fixation plate 121 was 20 mm.

Incidentally, with respect to the above metal heater, the outer rim of the region where the heating element was formed existed at a position of 15% of the diameter of the metal plate 111 from the outer circumference of the metal plate 111.

### Example 3

Production of a Metal Heater (see FIG. 3)

(1) After the upper metal plate 131 and the lower metal plate 141 were produced in the same manner as described in (1) and (2) in Example 1, the upper metal plate 131 and the lower metal plate 141 were subjected to the alumite treatment in the same manner as described in (3) in Example 1.

Incidentally, the upper metal plate 131 was produced so as to have a thickness of 2 mm and a diameter of 330 mm, and the lower metal plate 141 was produced so as to have a thickness of 20 mm and a diameter of 330 mm.

(2) Next, in the same manner as described in (4) to (7) in Example 1, the upper metal plate 131 and the lower metal plate 141 were united with the heater 132 and then installed in the supporting case 140 to obtain the metal heater 130.

Incidentally, with respect to the constitution of the metal heater of this Example, no screw hole was formed in the upper metal plate 131, and the screw heads of the metal plate fixing screws 137 were embedded in the lower metal plate 141, so that the bottom face of the lower metal plate 141 were brought into contact with the inner face of the supporting case 140.

Additionally, with respect to the above metal heater, the outer rim of the region where the heating element was formed existed at a position of 1% of the diameter of the upper metal plate 131 from the outer circumference of the upper metal plate 131.

### Example 4

Production of a Metal Heater

A metal heater was produced in the same manner as Example 3, except that the thickness of the upper metal plate was 5 mm and the thickness of the lower metal plate was 45 mm.

Incidentally, with respect to the above metal heater, the outer rim of the region where the heating element was formed existed at a position of 25% of the diameter of the upper metal plate from the outer circumference of the upper metal plate.

### Example 5

Production of a Metal Heater

A metal heater was produced in the same manner as Example 3, except that the thickness of the upper metal plate was 15 mm and the thickness of the lower metal plate was 20 mm.

Incidentally, with respect to the above the metal heater, the outer rim of the region where the heating element was formed existed at a position of 10% of the diameter of the upper metal plate from the outer circumference of the upper metal plate.

### Test Example 1

A metal heater was produced in the same manner as Example 1, except that the thickness of the metal plate was 55 mm in the steps (1) and (3) described in Example 1.

### Test Example 2

A metal heater was produced in the same manner as Example 1, except that the surface polishing treatment was not carried out for the surface on the heating face side of the disc plate for the metal plate in the step (2) in Example 1.

### Test Example 3

A metal heater was produced in the same manner as Example 1, except that the outer rim of the region where the heating element was formed was at a position of 30% of the diameter of the metal plate from the outer circumference of the metal plate in the step (4) in Example 1.

Electric power was applied to the metal heaters according to Examples 1 to 5 and Test Examples 1 to 3 to increase the temperature, and the respective metal heaters were evaluated by the following methods.

The results are shown in Table 1. The ratio (the outer rim position) of the distance between the outer circumference of each metal plate and the outer rim of the heating element to the diameter of the metal plate was shown in Table 1.

Evaluation Methods

(1) Temperature Evenness in Surface in Steady State

Each metal heater was heated to 140° C. and a temperature sensor-bearing wafer provided with thermocouples was placed on the heating face of the metal heater to measure the temperature distribution in the heating face. The temperature distribution was shown as the maximum value of the temperature difference of the highest temperature and the lowest temperature in the course of temperature elevation.

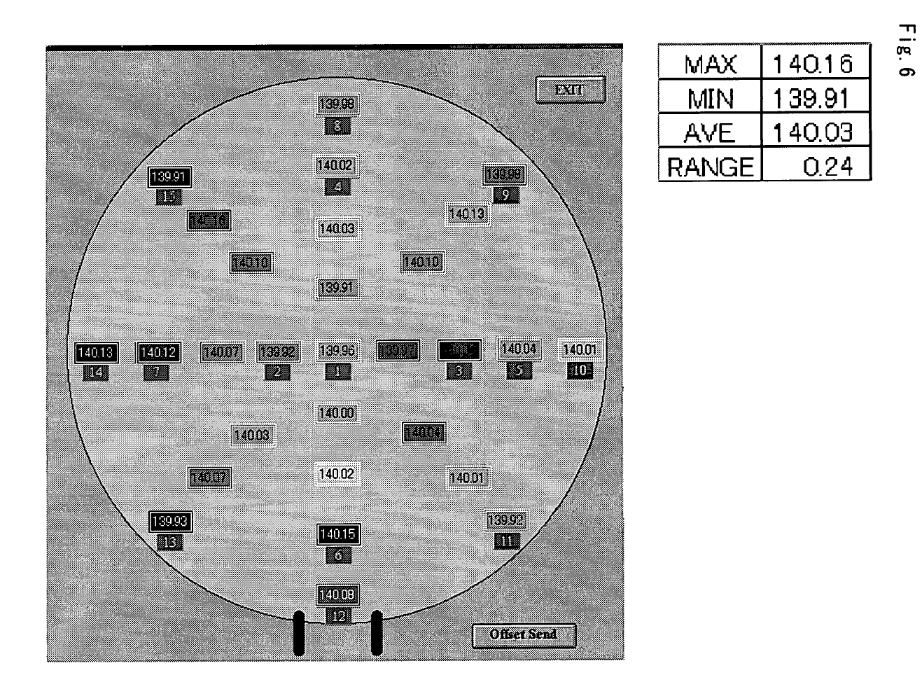

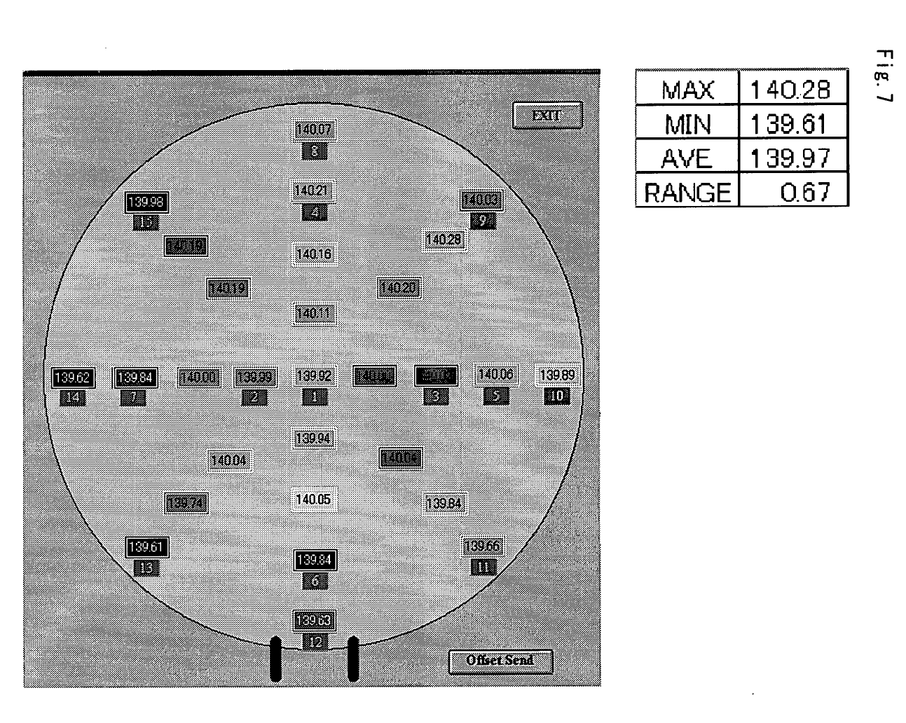

FIG. 6 shows the temperature at the respective measurement points of the heating face of the metal heater according to Example 1. FIG. 7 shows the temperature at the respective measurement points of the heating face of the metal heater according to Test Example 3.

(2) Temperature Evenness in Surface in Transition Period

The temperature sensor-bearing wafer was heated to 140° C. from a room temperature by using each metal heater to measure the temperature distribution in the surface of the temperature sensor-bearing wafer. The temperature distribution was measured at 100° C., 120° C., and 130° C. and shown as the maximum value of the temperature difference of the highest temperature and the lowest temperature.

(3) Temperature Elevation Time

The temperature elevation time taken for each metal heater to increase the temperature from a room temperature to 140° C. was measured.

(4) Recovery Time

The time (the recovery time) to restore a temperature of 140° C. was measured in the case the set temperature was 140° C. and a silicon wafer with a temperature of 25° C. was placed.

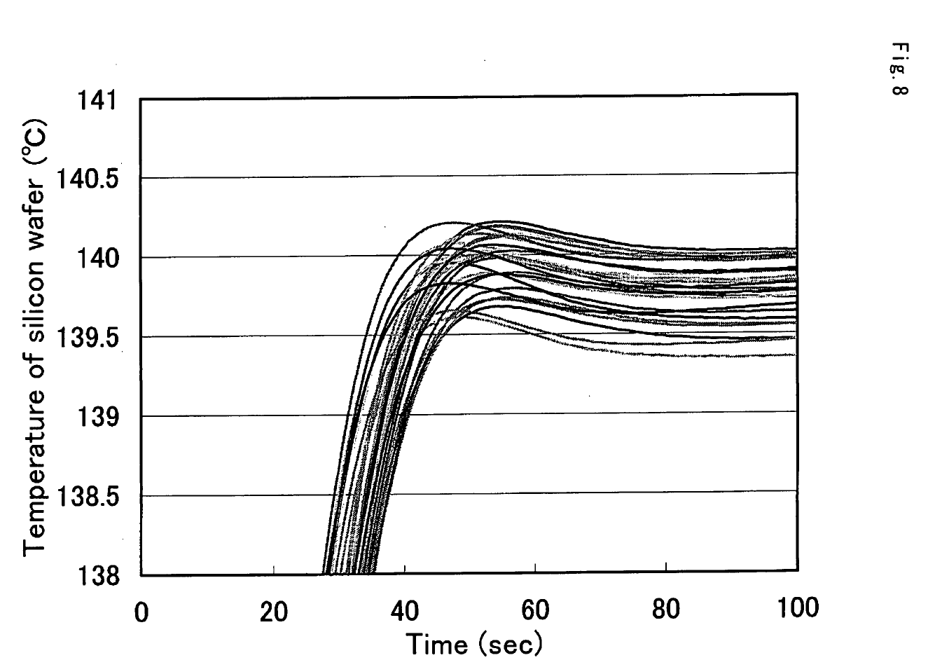

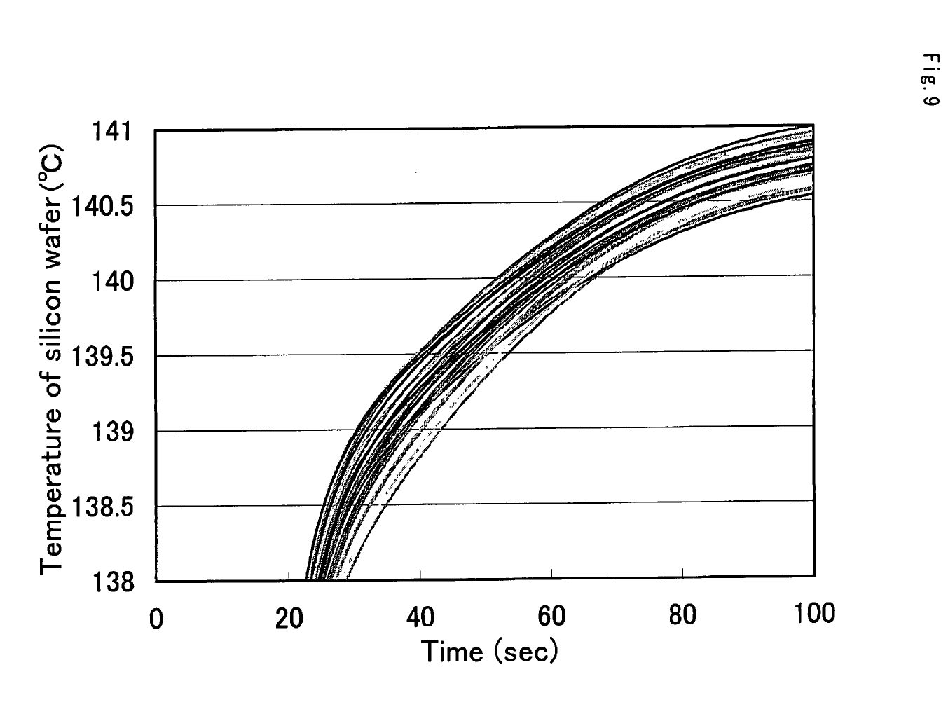

FIG. 8 shows the correlation between the temperature and the time at respective measurement points of a silicon wafer in the case the silicon wafer with a temperature of 25° C. is placed on the metal heater according to Example 2. FIG. 9 shows the correlation between the temperature and the time at respective measurement points of a silicon wafer in the case the silicon wafer with a temperature of 25° C. is placed on the metal heater according to Test Example 1.

(5) Measurement of Flatness

The flatness of heating face of each metal plate at ordinary temperatures and 140° C. was measured by using a laser displacement meter (manufactured by Keyence Corp.).

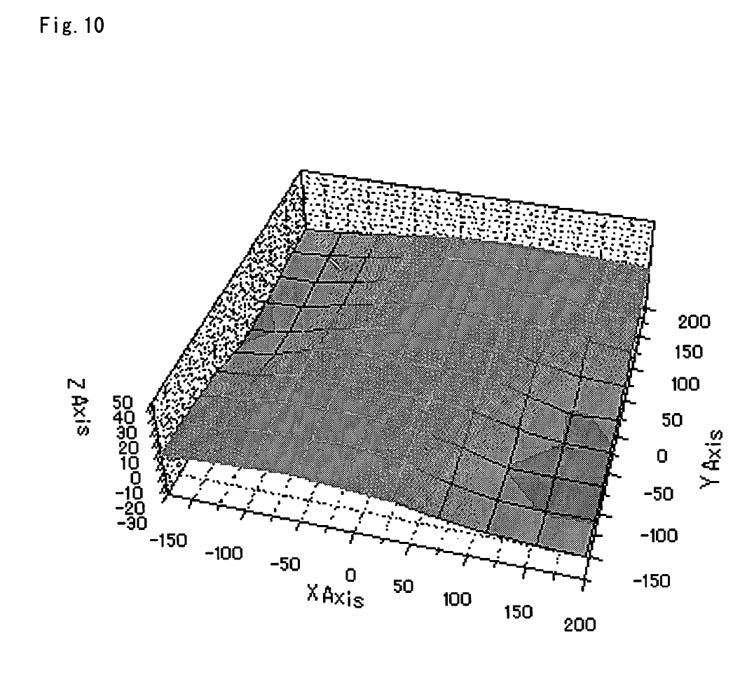

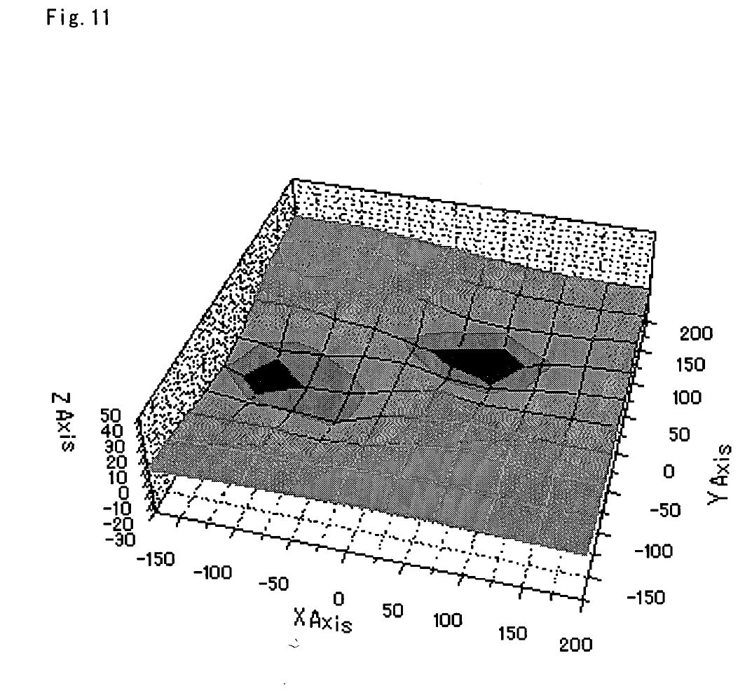

FIG. 10 shows a three-dimensional shape of the heating face of the metal heater according to Example 1 at 140° C. FIG. 11 shows a three-dimensional shape of the heating face of the metal heater according to Test Example 2 at 140° C.

TABLE 1

| | | | Distribution of | | | | | | | | |
|---|---|---|---|---|---|---|---|---|---|---|---|
| | Metal plate | | temperature | Distribution of | | | | | | | |
| | thickness (mm) | | in surface in | temperature in surface | | | | | | | Outer |
| | Upper | Lower | steady state | in transition period | | | Temperature | Recovery | Flatness (μm) | | rim |
| | metal | metal | (° C.) | (° C.) | | | elevation | time | At ordinary | At | position |
| | plate | plate | (140° C.) | 100° C. | 120° C. | 130° C. | time (sec) | (sec) | temperatures | 140° C. | (%) |
| Example 1 | 20 | 5 | 0.24 | 5.38 | 2.80 | 1.51 | 1367 | 32 | 29 | 35 | 7 |
| Example 2 | 5 | 20 | 0.29 | 5.75 | 2.10 | 1.46 | 1015 | 39 | 28 | 29 | 15 |
| Example 3 | 2 | 20 | 0.48 | 4.50 | 4.04 | 2.16 | 967 | 40 | 34 | 42 | 1 |
| Example 4 | 5 | 45 | 0.44 | 6.18 | 3.96 | 3.03 | 1008 | 48 | 33 | 38 | 25 |
| Example 5 | 15 | 20 | 0.49 | 5.23 | 3.47 | 1.94 | 1072 | 42 | 44 | 50 | 10 |
| Test | 55 | 5 | 0.61 | 9.11 | 8.10 | 4.46 | 1622 | 243 | 27 | 31 | 7 |
| Example 1 | | | | | | | | | | | |
| Test | 20 | 5 | 0.62 | 8.95 | 6.22 | 3.61 | 1407 | 267 | 55 | 56 | 7 |
| Example 2 | | | | | | | | | | | |
| Test | 20 | 5 | 0.67 | 12.67 | 10.00 | 5.57 | 1405 | 228 | 19 | 27 | 30 |
| Example 3 | | | | | | | | | | | |

As shown in Table 1 and FIG. 6, the metal heaters according to Examples 1 to 5 were found have even temperature in the heating faces of the metal plates in steady state and in transition period. It is supposedly attributed to that the distance between each metal plate and the sensor wafer did not have a dispersion since the flatness was 50 μm or less as shown in Table 1 and FIG. 10, so that the sensor wafer was evenly heated.

Also, it is supposedly attributed to that since heating element was formed in the outer circumferential part of the metal plate of each metal heater according to Examples 1 to 5, the temperature difference between the center part and the outer circumferential part was narrowed in the heating face of the metal plate.

Further, as shown in Table 1 and FIG. 8, the temperature elevation time and the recovery time were found to be short in each of metal heaters according to Examples 1 to 5. It is supposedly attributed that since the thickness of each metal plate was 50 mm or less with respect to the metal heaters according to Examples 1 to 5, the temperature of the heating face of the metal plate promptly followed the temperature change of the heating element, and thus the object to be heated was quickly heated.

On the other hand, as shown in Table 1 and FIG. 9, the metal heater according to Test Example 1 was inferior to the metal heaters according to Examples 1 to 5 with respect to the temperature elevation time and the recovery time. From the results, it was found that the thickness of the metal plate is desirably 50 mm or less.

With respect to the metal heater according to Test Example 2, as shown in Table 1, the temperature evenness in the heating face of the metal heater in steady state and in transition period was poor. The metal heater according to Test Example 2, as shown in FIG. 11, had an insufficient flatness of the heating face. From the results, it was found that the flatness of the surface of the metal plate is desirably 50 μm or less.

Further, comparison of the temperature evenness (see Table 1 and FIG. 7) in the heating face of the metal heater according to Test Example 3 and the temperature evenness in the heating face of each of metal heaters according to Examples 1 to 5 made it clear that the heating element is desirably formed in the outer circumferential part of the metal plate.

### Example 6

Production of a Metal Heater (see FIG. 3)

(1) Plates comprising an aluminum-copper alloy (A 2219 (JIS-H4000)) were formed into a disc shape by outer-diameter machining using an NC lathe (manufactured by Washino Machinery Co., Ltd.). The disc plates were further subjected to the end face machining, front face machining and rear face machining to produce disc plates for the upper metal plate and the lower metal plate.

Next, using a machining center (manufactured by Hitachi Seiki Co., Ltd.), parts to be the through holes 135 to insert lifter pins for supporting a semiconductor wafer 139, concave portions for installing the supporting pins 138, and a part to be the bottomed hole 134 for embedding the temperature measuring element 136 were formed in these disc plates. Further, after the bottomed hole or through holes were formed at prescribed positions in the same manner, screw grooves were formed in the bottomed hole or through holes to form screw holes to insert the metal plate fixing screws 137 in the disc plates.

Incidentally, the through holes 135 were formed at three points, and the concave portions for installation of the supporting pins 138 were formed at four points.

(2) Next, a surface polishing treatment was performed to the surface on the heating face side of the disc plate for the upper metal plate produced in the step (1) by a rotary grinder (manufactured by Okamoto Machine Tool Works Ltd.) to obtain the upper metal plate 131 with a thickness of 5 mm and a diameter of 330 mm and the lower metal plate 141 with a thickness of 15 mm and a diameter of 330 mm.

Incidentally, in this example, the upper metal plate 131 was thinner than the lower metal plate 141.

(3) Next, the upper metal plate 131 and the lower metal plate 141 were subjected to an alumite treatment in an electrolytic solution containing 10% H₂SO₄ under the conditions of voltage 10 V, current density 0.8 A/dm², and a solution temperature 20° C. to form oxide films with a thickness of 15 μm on the surfaces of the upper metal plate 131 and the lower metal plate 141.

(4) Heating element 145 comprising a Nichrome wire and formed into a pattern of circular repeated winding lines and a pattern of repeated winding lines tracing apart of a concentric circle as shown in FIG. 2 was sandwiched between two mica plates 146 with a thickness of 0.3 mm to obtain the heater 132 with a diameter of 330 mm.

Incidentally, with respect to the heater 132, the heating element 145 was so formed as to have the outer rim of the heating element be at a position within 25% of the diameter of the upper metal plate 131 from the outer circumference of the upper metal plate 131. The total number of the circuits of the heating element 145 was 4.

Further, parts to be the through holes 135, a part to be the bottomed hole 134, and parts to be the screw holes to insert the metal plate fixing screws 137 were previously formed in the mica plates 146.

After that, the heater 132 was sandwiched between the upper metal plate 131 and the lower metal plate 141 produced in the steps (1) to (3), and the metal plate fixing screws 137 were inserted into the screw holes formed in the lower metal plate 141 and the heater 132 and fastened to unite the upper metal plate 131, the lower metal plate 141, and the heater 132.

(5) Next, the supporting case 140 comprising SUS having a cylindrical shape as shown in FIG. 3 was produced. After the parts to be the through holes 135, the part to be the bottomed hole 134, and the through hole to insert the conductive wire 144 were formed in the bottom face of the supporting case 140, the heat shielding plate 143 comprising SUS and having a disc shape was installed in the bottom part of the supporting case 140.

After that, the upper metal plate 131, to which the heater 132 and the lower metal plate 141 were attached and which was produced in the step (4), was installed in the inside of the supporting case 140 having the heat shielding plate 143 therein, and a presser 142 was attached to the outer circumferential part of the heating face of the upper metal plate 131 to fix the upper metal plate 131 in the inside of the supporting case 140.

Incidentally, with respect to the metal heater in this Example, the screw heads of the metal plate fixing screws 137 were embedded in the lower metal plate 141 so that the bottom face of the lower metal plate 141 was brought into contact with the inside face of the supporting case 140.

(6) After the temperature measuring element 136 for controlling the temperature was inserted into the bottomed hole 134, the bottomed hole 134 was sealed with a polyimide. Further, the supporting pins 138 were installed in the concave portions formed in the heating face of the upper metal plate 131.

(7) Next, the conductive wire 144 for connecting to the electric power source was attached to both ends of the heating element installed in the heater 132 by pressure bonding and connected to an electric power source in the outside to obtain the metal heater 130.

### Example 7

Production of a Metal Heater

A metal heater was produced in the same manner as Example 6, except that the thickness of the upper metal plate 131 was 5 mm and the thickness of the lower metal plate 141 was 20 mm.

Incidentally, in this Example, the upper metal plate 131 was thinner than the lower metal plate 141.

### Example 8

Production of a Metal Heater

A metal heater was produced in the same manner as Example 6, except that the thickness of the upper metal plate 131 was 10 mm and the thickness of the lower metal plate 141 was 10 mm.

Incidentally, in this example, the thickness of the upper metal plate and the thickness of the lower metal plate were the same.

### Example 9

Production of a Metal Heater

A metal heater was produced in the same manner as Example 6, except that the thickness of the upper metal plate 131 was 4 mm and the thickness of the lower metal plate 141 was 40 mm.

Incidentally, in this example, the upper metal plate 131 was thinner than the lower metal plate 141.

### Example 10

Production of a Metal Heater

A metal heater was produced in the same manner as Example 6, except that the thickness of the upper metal plate 131 was 4 mm and the thickness of the lower metal plate 141 was 44 mm.

Incidentally, in this example, the upper metal plate 131 was thinner than the lower metal plate 141.

### Comparative Example 1

As shown in FIG. 4, a metal heater was produced by installing an intermediate plate comprising copper and a heater in the bottom face of a metal plate and attaching no presser to the outer circumferential part of the heating face of the metal plate. Incidentally, the thickness of the metal plate was 55 mm and a heating element had the same pattern as that of Example 6.

Electric power was applied to the metal heaters according to Examples 6 to 10 and Comparative Example 1 to increase the temperature, and (1) Temperature evenness in surface in steady state, (2) Temperature evenness in surface in transition period, (3) Temperature elevation time, (4) Recovery time, and (5) Measurement of flatness were evaluated. The results are shown in Table 2. The practical evaluation methods were the same as those described in Example 1.

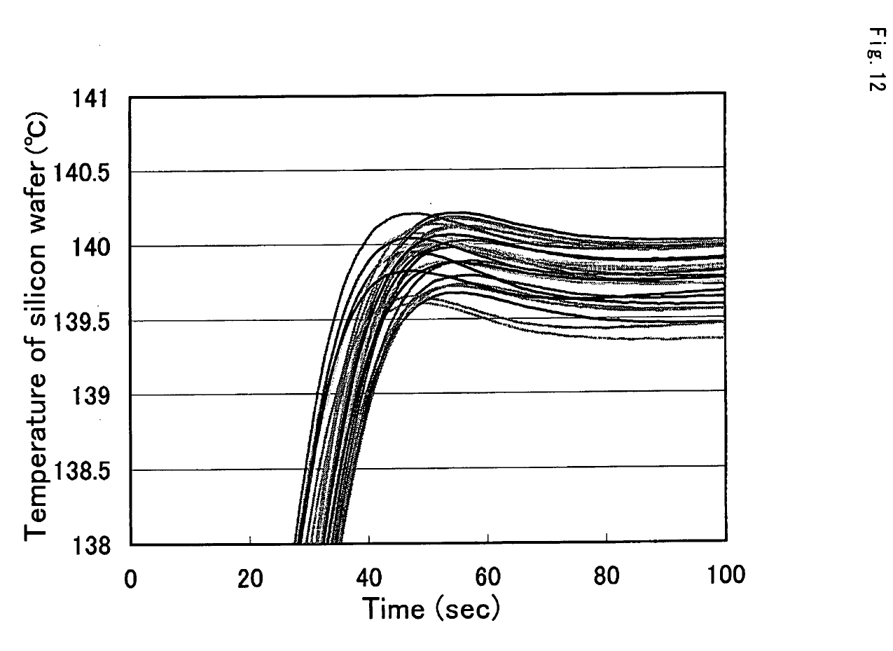

Also, with respect to the evaluation of (4) Recovery time, FIG. 12 shows the correlation between the temperature and the time at respective measurement points of a silicon wafer in the case the silicon wafer with a temperature of 25° C. is placed on the metal heater according to Example 7.

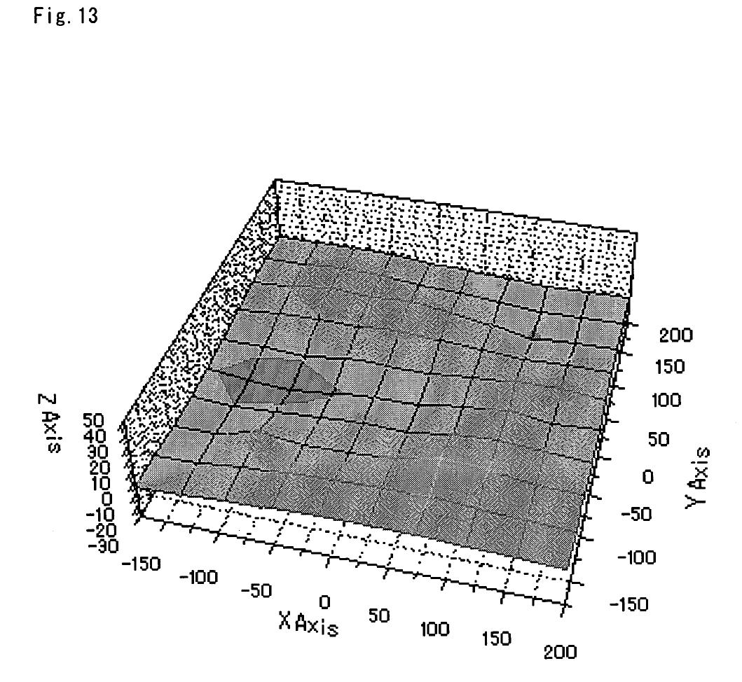

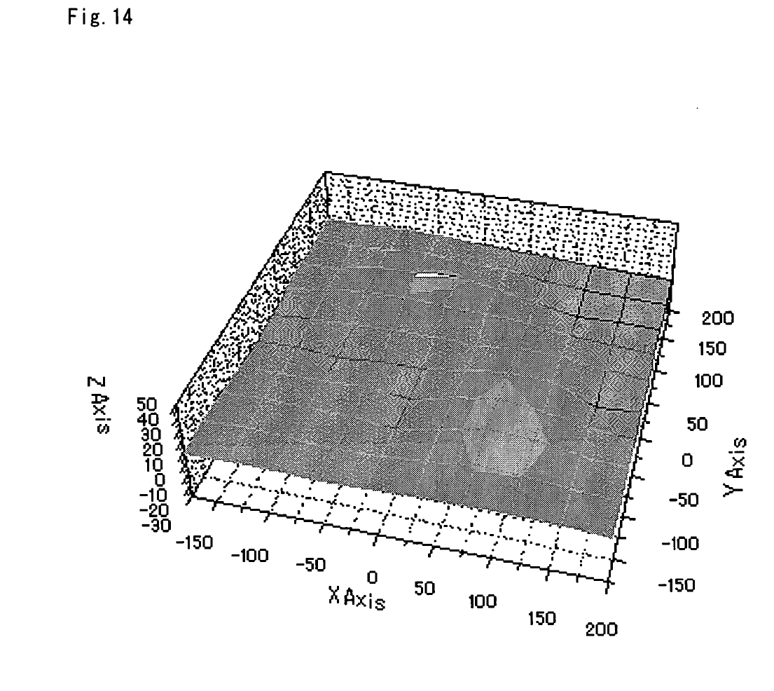

Also, with respect to the result of (5) Flatness measurement, FIG. 13 shows a three-dimensional shape of the heating face of the metal heater according to Example 7 at ordinary temperatures. FIG. 14 shows a three-dimensional shape of apart of the heating face of the metal heater according to Example 7 at 140° C.

TABLE 2

| | | | Distribution of | | | | | | | |
|---|---|---|---|---|---|---|---|---|---|---|
| | Metal plate | | temperature | Distribution of | | | | | | |
| | thickness (mm) | | in surface in | temperature in surface | | | | | | |
| | Upper | Lower | steady state | in transition period | | | Temperature | Recovery | Flatness (μm) | |
| | metal | metal | (° C.) | (° C.) | | | elevation | time | At ordinary | At |
| | plate | plate | (140° C.) | 100° C. | 120° C. | 130° C. | time (sec) | (sec) | temperatures | 140° C. |
| Example 6 | 5 | 15 | 0.30 | 6.58 | 2.23 | 1.50 | 945 | 37 | 29 | 36 |
| Example 7 | 5 | 20 | 0.29 | 5.75 | 2.10 | 1.46 | 1015 | 39 | 28 | 29 |
| Example 8 | 10 | 10 | 0.28 | 7.00 | 3.00 | 2.00 | 1100 | 50 | 35 | 40 |
| Example 9 | 4 | 40 | 0.30 | 4.21 | 1.80 | 1.20 | 800 | 20 | 25 | 26 |
| Example 10 | 4 | 44 | 0.33 | 4.20 | 1.70 | 1.10 | 1380 | 105 | 22 | 25 |
| Test | 20 | 5 | 0.62 | 8.95 | 6.22 | 3.61 | 1407 | 267 | 55 | 56 |
| Example 2 | | | | | | | | | | |
| Test | 20 | 5 | 0.67 | 12.67 | 10.00 | 5.57 | 1405 | 228 | 19 | 27 |
| Example 3 | | | | | | | | | | |
| Comparative | 55 | 0 | 1.80 | 11.00 | 5.66 | 3.50 | 2530 | 293 | 44 | 56 |
| Example 1 | | | | | | | | | | |

As shown in Table 2, the metal heaters according to Examples 6 to 10 were found have even temperature in the heating faces of the upper metal plates in steady state and in transition period. It is supposedly attributed to that the distance between each upper metal plate and the sensor wafer did not have a dispersion since the flatness was 50 μm or less as shown in Table 2 and FIGS. 13 and 14, so that the sensor wafer was evenly heated.

Also, it is supposedly attributed to that since the lower metal plate with a prescribed thickness was installed in the bottom face of each of the metal heaters according to Examples 6 to 10, heat ray radiated form the heater is made even.

Further, as shown in Table 2 and FIG. 12, the temperature elevation time and the recovery time were found to be short with respect to each of the metal heaters according to Examples 6 to 10. It is supposedly attributed that since the thickness of each upper metal plate was thin, the temperature of the heating face of the metal plate promptly followed the temperature change of the heating element, and thus the object to be heated was quickly heated.

These results are apparently understood by comparison of the evaluation results of the metal heaters according to Test Examples 2 and 3.

On the other hand, with respect to the metal heater according to Comparative Example 1, the temperature elevation speed and the recovery time were prolonged. It is supposedly attributed to that the thickness of the metal plate was large.

### Example 11

Production of a Metal Heater (see FIGS. 1 and 2)

(1) Plates comprising a commercially available aluminum-copper alloy No. A 2219 according to JIS-H4000 were formed into a disc shape by outer-diameter machining using an NC lathe (manufactured by Washino Machinery Co., Ltd.). The disc plates were further subjected to the end face machining, front face machining and rear face machining to produce a disc plate for the metal plate and a disc plate for the heater fixation plate.

Next, using a machining center (manufactured by Hitachi Seiki Co., Ltd.), parts to be the through holes 115 to insert lifter pins for supporting the semiconductor wafer 119, concave portions for installing the supporting pins 118, and a part to be the bottomed hole 114 for embedding the temperature measuring element 116 were formed in these disc plates. Further, after the bottomed hole or through holes were formed at prescribed positions in the same manner, screw grooves were formed in the bottomed hole or through holes to form screw holes to insert the metal plate fixing screws 117 in the disc plates.

Incidentally, the through holes 115 were formed at three points, and the concave portions for installation of the supporting pins 118 were formed at four points.

(2) Next, a surface polishing treatment was performed to the surface on the heating face side of the disc plate for the metal plate produced in the step (1) by a rotary grinder (manufactured by Okamoto Machine Tool Works Ltd.) to obtain the metal plate (upper metal plate) 111 with a thickness of 20 mm and a diameter of 330 mm and the heater fixation plate (lower metal plate) 121 with a thickness of 5 mm and a diameter of 330 mm.

(3) Next, the metal plate 111 and the heater fixation plate 121 were subjected to an alumite treatment in an electrolytic solution containing 10% H₂SO₄ under the conditions of voltage 10 V, current density 0.8 A/dm², and a solution temperature 20° C. to form oxide films with a thickness of 15 μm on the surfaces of the metal plate 111 and the heater fixation plate 121.

(4) A heating element 125 comprising a Nichrome wire and formed into a pattern of circular repeated winding lines and a patter of repeated winding lines tracing a part of a concentric circle as shown in FIG. 2 was sandwiched between two mica plates 126 with a thickness of 0.3 mm to obtain a heater 112 with a diameter of 330 mm.

Incidentally, with respect to the heater 112, the heating element 125 was so formed as to have the outer rim of the heating element be at a position within 25% of the diameter of the metal plate 111 from the outer circumference of the metal plate 111. The total number of the circuits of the heating element 125 was 4.

Further, parts to be the through holes 115, a part to be the bottomed hole 114, and parts to be the screw holes to insert the metal plate fixing screws 117 were previously formed in the mica plates 126.

After that, the heater 112 was sandwiched between the metal plate 111 and the heater fixation plate 121 produced in the steps (1) to (3), and the metal plate fixing screws 117 were inserted into the screw holes formed in the metal plate 111, the heater fixation plate 121, and the heater 112 and fastened to unite the metal plate 111, the heater fixation plate 121, and the heater 112.

(5) Next, the supporting case 120 comprising SUS having a cylindrical shape as shown in FIG. 1 was produced. After the parts to be the through holes 115, the part to be the bottomed hole 114, and the through hole to insert the conductive wire 124 were formed in the bottom face of the supporting case 120, the heat shielding plate 123 comprising SUS and having a disc shape was installed in the bottom part of the supporting case 120.

After that, the metal plate 111, to which the heater 112 and the heater fixation plate 121 were attached and which was produced in the step (4), was installed in the inside of the supporting case 120 having the heat shielding plate 123 therein, and a presser 122 was attached to the outer circumferential part of the heating face of the metal plate 11 to fix the metal plate 111 in the inside of the supporting case 120.

(6) After the temperature measuring element 116 for controlling the temperature was inserted into the bottomed hole 114, the bottomed hole 114 was sealed with a polyimide. The supporting pins 118 were installed in the concave portions formed in the heating face of the metal plate 111.

(7) Next, the conductive wire 124 for connecting to the electric power source was attached to both ends of the heating element installed in the heater 112 by pressure bonding and connected to an electric power source in the outside to obtain the metal heater 110.

### Example 12

Production of a Metal Heater

A metal heater was produced by using a commercially available aluminum-copper alloy No. A2219 according to JIS-H4000 in the same manner as Example 11, except that the thickness of the metal plate 111 was 5 mm and the thickness of the heater fixation plate 121 was 20 mm.

### Example 13

Production of a Metal Heater (see FIG. 3)

(1) After the upper metal plate 131 and the lower metal plate 141 were produced in the same manner as described in (1) and (2) in Example 11, except that a commercially available aluminum-copper alloy No. A2018 according to JIS-H4000 was used, the upper metal plate 131 and the lower metal plate 141 were subjected to an alumite treatment in the same manner as described in (3) in Example 11.

Incidentally, the upper metal plate 131 was produced so as to have a thickness of 5 mm and a diameter of 330 mm and the lower metal plate 141 was produced so as to have a thickness of 20 mm and a diameter of 330 mm.

(2) Next, in the same manner as described in (4) to (7) in Example 11, the upper metal plate 131, the lower metal plate 141, and the heater 132 were united and then installed in the supporting case 140 to obtain the metal heater 130.

Additionally, in the metal heater of this example, no screw hole was formed in the upper metal plate 131, and the screw heads of the metal plate fixing screws 137 were embedded in the lower metal plate 141, so that the bottom face of the lower metal plate 141 was brought into contact with the inner face of the supporting case 140.

### Example 14

Production of a Metal Heater

A metal heater was produced in the same manner as Example 13, except that a commercially available aluminum-copper alloy No. A5052 according to JIS-H4000 was used, the thickness of the upper metal plate was 5 mm and the thickness of the lower metal plate was 20 mm.

### Test Example 4

Production of a Metal Heater

A metal heater was produced in the same manner as Example 11, except that a commercially available pure aluminum (purity 99.9%) No. A1085 according to JIS-H4000 was used in the step (1) of Example 11.

### Test Example 5

Production of a Metal Heater

A metal heater was produced in the same manner as Example 11, except that a commercially available aluminum alloy No. A4032 (purity 85%) according to JIS-H4000 was used in the step (1) of Example 11.

Incidentally, step (3) of Example 11 was not carried out in this Test Example.

### Test Example 6

Production of a Metal Heater

A metal heater was produced in the same manner as Example 11, except that a pure aluminum with a purity of 100% was used in the step (1) of Example 11.

### Comparative Example 2

As shown in FIG. 4, a metal heater was produced by installing an intermediate plate comprising copper and a heater in the bottom face of a metal plate and attaching no presser to the outer circumferential part of the heating face of the metal plate. Incidentally, the thickness of the metal plate was 60 mm, and the heating element had the same pattern as that of Example 11.

Electric power was applied to the metal heaters according to Examples 11 to 14, Test Examples 4 to 6, and Comparative Example 2 to increase the temperature, and (1) Temperature evenness in surface in steady state, (2) Temperature evenness in transition period, (3) Temperature elevation time, (4) Recovery time, and (5) Measurement of flatness were evaluated. The results are shown in Table 3. In Table, the thickness of the metal plate means the thickness of the upper metal plate in the case the metal heater comprises the upper metal plate and the lower metal plate. The evaluation methods were the same as those described in Example 1.

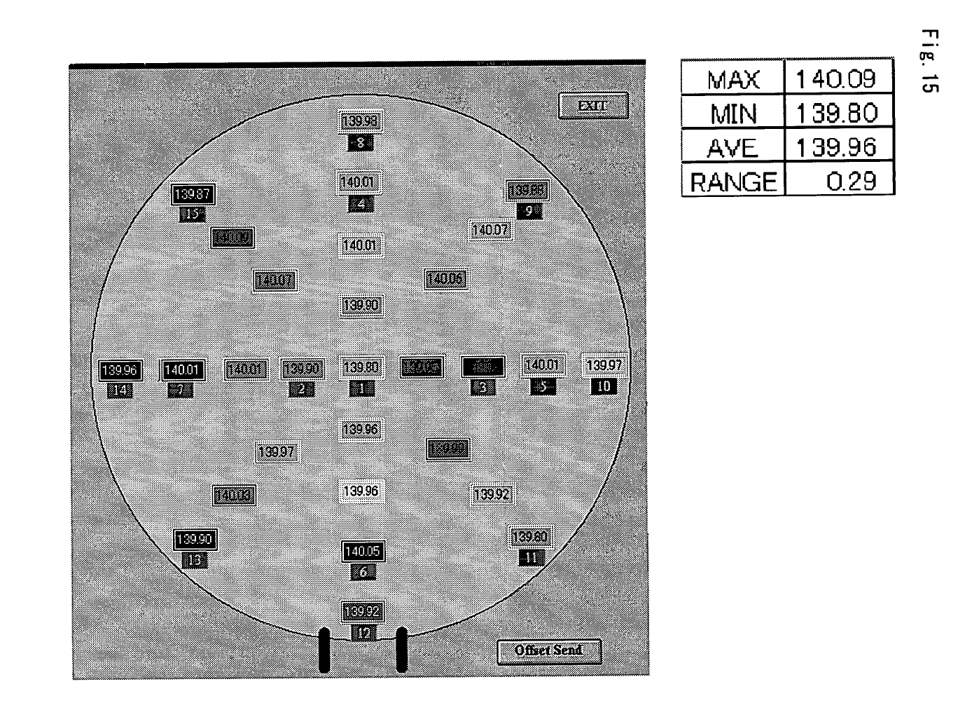

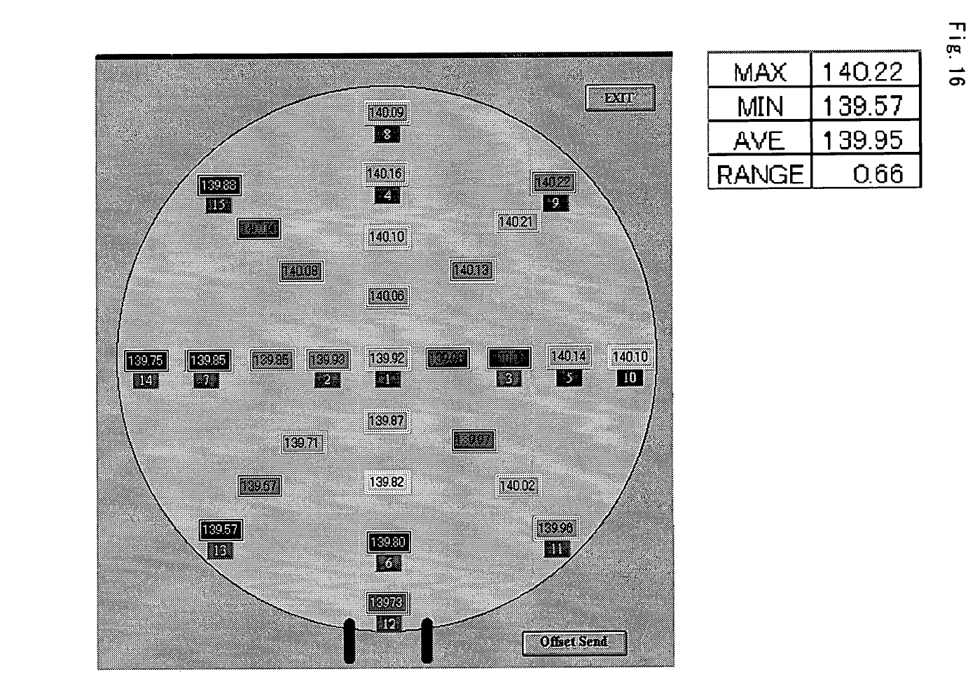

With respect to the evaluation results of the (1) Temperature evenness in surface in steady state, FIG. 15 shows the temperature at the respective measurement points of the heating face of the metal heater according to Example 13. FIG. 16 shows the temperature at the respective measurement points of the heating face of the metal heater according to Test Example 4.

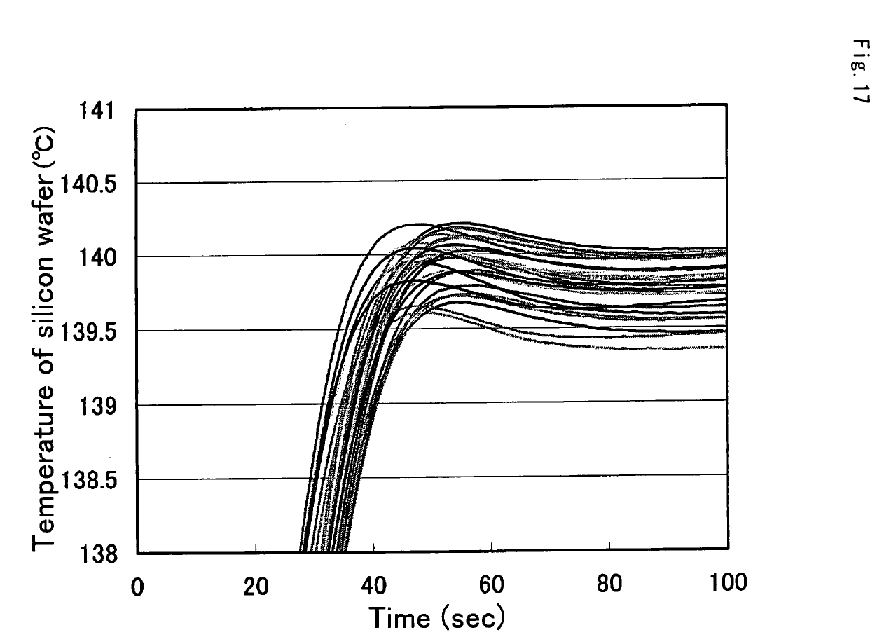

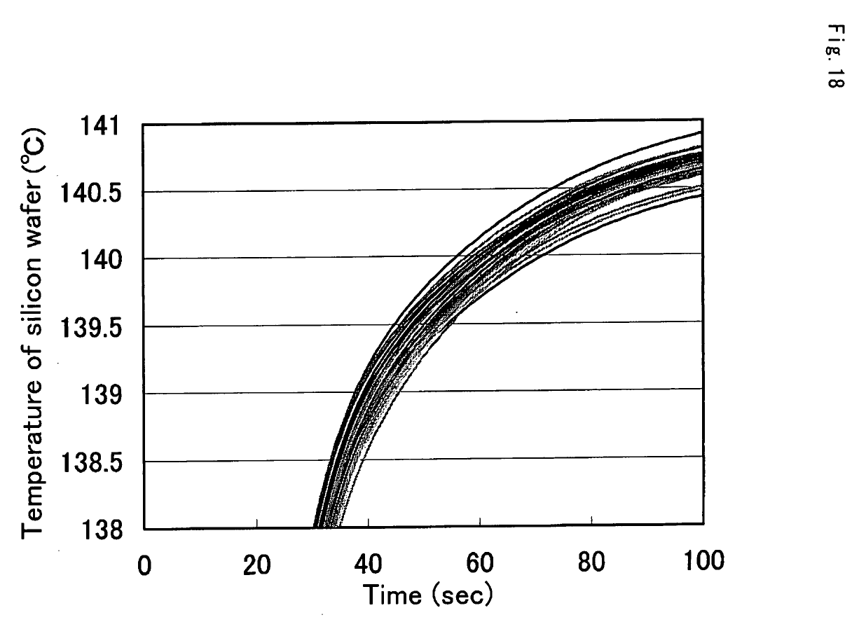

Further, with respect to the evaluation results of the (4) Recovery time, FIG. 17 shows the correlation between the temperature and the time at respective measurement points of a silicon wafer in the case the silicon wafer with a temperature of 25° C. is placed on the metal heater according to Example 14. FIG. 18 shows the correlation between the temperature and the time at respective measurement points of a silicon wafer in the case the silicon wafer with a temperature of 25° C. is placed on the metal heater according to Comparative Example 2.

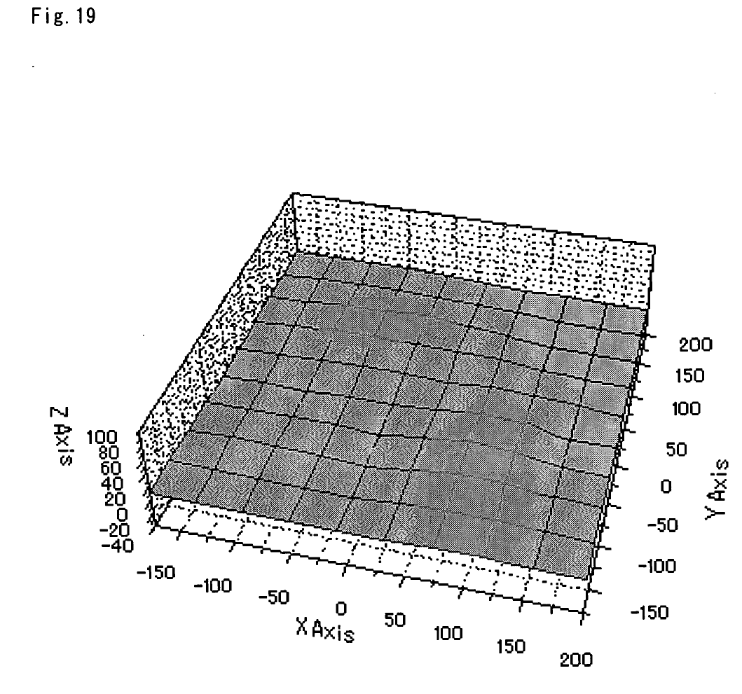

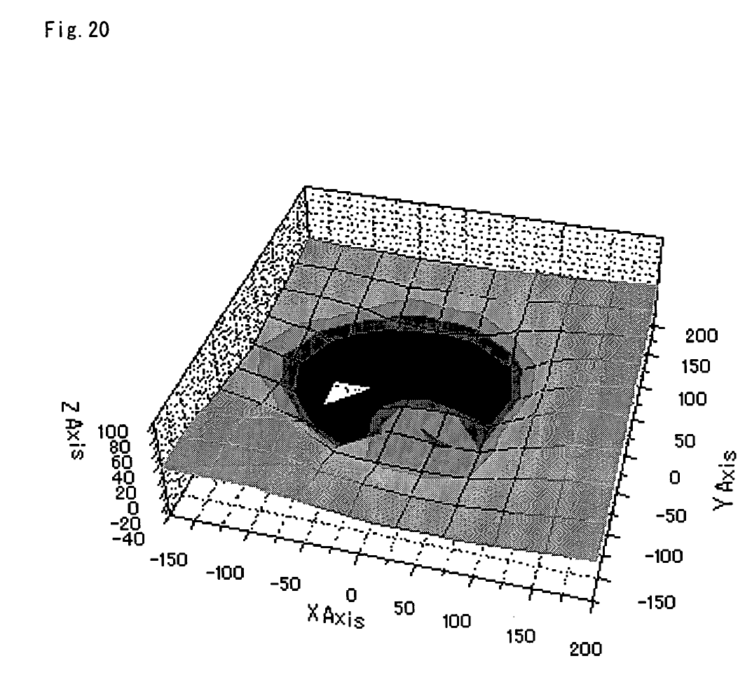

Also, with respect to the evaluation results of the (5) Flatness, FIG. 19 shows a three-dimensional shape of the heating face of the metal heater according to Example 13 at 140° C. FIG. 20 shows a three-dimensional shape of the heating face of the metal heater according to Test Example 5 at 140° C.

TABLE 3

| | | | Distribution of | | | | | | | | | |
|---|---|---|---|---|---|---|---|---|---|---|---|---|
| | Metal plate | | temperature | Distribution of | | | | | | | | |
| | thickness (mm) | | in surface in | temperature in surface | | | | | | | | |
| | Upper | Lower | steady state | in transition period | | | Temperature | Recovery | Flatness (μm) | | Composition | |
| | metal | metal | (° C.) | (° C.) | | | elevation | time | At ordinary | At | (%) | |
| | plate | plate | (140° C.) | 100° C. | 120° C. | 130° C. | time (sec) | (sec) | temperatures | 140° C. | Cu | Al |
| Example 11 | 20 | 5 | 0.24 | 5.38 | 2.80 | 1.51 | 1367 | 200 | 29 | 30 | 6.3 | 93.1 |
| Example 12 | 5 | 20 | 0.29 | 5.75 | 2.10 | 1.46 | 1015 | 39 | 28 | 29 | 6.3 | 93.1 |
| Example 13 | 5 | 20 | 0.29 | 5.72 | 2.23 | 2.34 | 1017 | 40 | 30 | 32 | 4.0 | 91.8 |
| Example 14 | 5 | 20 | 0.44 | 9.56 | 6.66 | 5.10 | 1008 | 48 | 37 | 47 | 0.1 | 97.3 |
| Test | 20 | 5 | 0.66 | 14.74 | 10.75 | 8.75 | 1500 | 310 | 47 | 98 | 0.05 | 99.9 |
| Example 4 | | | | | | | | | | | | |
| Test | 20 | 5 | 0.40 | 19.19 | 14.30 | 10.10 | 1511 | 280 | 37 | 113 | 0.9 | 85.0 |
| Example 5 | | | | | | | | | | | | |
| Test | 20 | 5 | 0.66 | 15.01 | 10.89 | 8.84 | 1495 | 308 | 47 | 97 | 0 | 100.0 |
| Example 6 | | | | | | | | | | | | |
| Comparative | 60 | 0 | 0.50 | 15.38 | 12.80 | 11.22 | 1520 | 300 | 39 | 98 | 100 | 0 |
| Example 2 | | | | | | | | | | | | |

As shown in Table 3 and FIG. 15, the metal heaters according to Examples 11 to 14 were found have even temperature in the heating faces of the metal plates in steady state and in transition period. It is supposedly attributed to that since aluminum-copper alloys with high mechanical strength were used for the material for the metal plates as shown in Table 3 and FIG. 19, no warping or sagging occurred for the metal plates at the time of heating, and thus the semiconductor wafer was heated evenly.

Further, as shown in Table 3 and FIG. 17, the temperature elevation time and the recovery time were found to be short in each of the metal heaters according to Examples 11 to 14. It is supposedly attributed to that since aluminum-copper alloys were used for metal plates in the metal heaters according to Examples 11 to 14, the thickness of the metal plates was reduced, and thus the object to be heated was quickly heated.

On the other hand, as shown in Table 3 and FIG. 16, the metal heater according to Test Example 4 was inferior to the metal heaters according to Examples 11 to 14 with respect to the temperature evenness in the heating face of the metal plate, the temperature elevation time and the recovery time. From the results, it was found again that the aluminum-copper alloys are excellent as the materials for the metal plates.

Further, with respect to the metal heater according to Test Example 5, as shown in Table 3, the temperature evenness in the heating face of the metal plate in steady state and in transition period was poor. Also, the metal heater according to Test Example 5, as shown in FIG. 20, was inferior to the metal heaters according to Examples 11 to 14 in the flatness of the heating face. From the results, it was found again that the aluminum-copper alloys are excellent as the materials for the metal plates.

Further, as shown in Table 3, the metal heater according to Test Example 6 was inferior to the metal heaters according to Examples 11 to 14 in the temperature evenness in the heating face of the metal plate, the temperature elevation time and the recovery time. From the results, it was found again that the aluminum-copper alloys are excellent as the materials for the metal plates.

Further, with respect to the metal heater according to Comparative Example 2, as shown in Table 3 and FIG. 18, the temperature elevation speed and the recovery time were prolonged. It was supposedly attributed to the large thickness of the metal plate.

### INDUSTRIAL APPLICABILITY

As described above, with respect to the metal heater of the first aspect of the present invention, since the thickness of the metal plate is as small as 50 mm or less, the temperature of the heating face of the metal plate promptly follows the change of the voltage and the electric current quantity applied to the heating element, and thus an object to be heated such as a semiconductor wafer can be heated quickly. Also, because of the excellent temperature following character of the metal plate as described, the recovery time can be shortened, throughput time can be shortened, and productivity can be improved.

Further, the metal plate constituting the metal heater of the first aspect of the present invention has a surface with a flatness of 50 μm or less. Accordingly, in the case of heating a semiconductor wafer by using the metal heater of the first aspect of the present invention, the distance between the semiconductor wafer and the metal plate can be kept approximately even, and therefore, the entire semiconductor wafer can be heated evenly.

Further, in the metal heater of the first aspect of the present invention, the outer rim of the region where the heating element is formed exists at a position within 25% of the diameter of the metal plate from the outer circumference of the metal plate, so that the semiconductor wafer and the like, an object be heated, can be heated evenly without a dispersion of temperature.

As described above, with respect to the metal heater of the second aspect of the present invention, the metal plate can be made thinner than that of a metal heater comprising only a single metal plate, and the heat capacity of the metal plate on the heating face side can be lowered. Therefore, an object to be heated such as a semiconductor wafer can be heated quickly.

Further, since the metal plate is excellent in temperature-following character, in the case the semiconductor wafer is placed on the heating face of the metal heater in the semiconductor producing/examining process, the time (the recovery time) taken to bring the decreased temperature back to the previous temperature can be shortened, so that the throughput time can be shortened and the productivity can be improved.

In the metal heater of the second aspect of the present invention, the thickness of the metal plate on the heating face side is the same as or smaller than the thickness of the metal plate on the side opposite to the heating face side.

Accordingly, even if the thickness of the metal plate on the heating face side is small, the strength of the entire body of the metal heater can be maintained by installing the metal plate with a high rigidity on the side opposite to the heating face side, and since the flatness of the heating face at the time of heating is improved, the distance between the semiconductor wafer and the metal plate can be kept approximately even, and the entire semiconductor wafer can be heated evenly.

As described above, the metal heater of the third aspect of the present invention comprises a metal plate comprising an aluminum-copper alloy. Since the aluminum-copper alloy has a high mechanical strength, even if the metal plate is thin, the metal plate is not warped or sagged by heating. Therefore, the metal plate can be made thin and light.

Further, since the aluminum-copper alloy is also excellent in thermal conductivity, in the case of using the alloy for the metal plate, the temperature of the heating face can promptly follow the temperature change of the heating element. That is, the heating face temperature of the metal plate can be controlled by changing the temperature of the heating element by controlling the voltage and the electric current.

Also, since the aluminum-copper alloy is excellent in cutting property, the metal plate can easily be formed into a desired shape.

1. A metal heater comprising a metal plate and a heating element,
wherein
said metal plate has a thickness of 50 mm or less and a surface flatness of 50 μm or less, and
an outer rim of a region where said heating element is formed is at a position within 25% of a diameter of said metal plate from an outer circumference of said metal plate.

2. A metal heater comprising a metal plate and a heating element,
wherein
the number of said metal plate is a plural number, said heating element is interposed between said metal plates, and
a thickness of a metal plate on a heating face side is the same as or smaller than that of a metal plate on a side opposite to said heating face side.

3. A metal heater comprising a metal plate and a heating element,
wherein
said metal plate comprises an aluminum-copper alloy.
